(19) United States
(12) Patent Application Publication
(10) Pub. No.: US 2017/0249232 A1
(43) Pub. Date: Aug. 31, 2017

(54) STORAGE MEDIUM STORING PERFORMANCE DEGRADATION CAUSE ESTIMATION PROGRAM, PERFORMANCE DEGRADATION CAUSE ESTIMATING DEVICE, AND PERFORMANCE DEGRADATION CAUSE ESTIMATION METHOD

(71) Applicant: FUJITSU LIMITED, Kawasaki-shi (JP)

(72) Inventor: Tatsuma MATSUKI, Kawasaki (JP)

(73) Assignee: FUJITSU LIMITED, Kawasaki-shi (JP)

(21) Appl. No.: 15/423,219

(22) Filed: Feb. 2, 2017

(30) Foreign Application Priority Data
Feb. 29, 2016 (JP) 2016-038084

(51) Int. Cl. G06F 11/36; G06F 11/30; G06F 11/34; H04L 12/26

(52) U.S. Cl. CPC G06F 11/3612; H04L 43/065; G06F 11/302; G06F 11/3419; G06F 11/3452

(57) ABSTRACT

A performance degradation cause estimation method includes: for each of access types, calculating first access densities in respective time periods obtained by dividing a first time period by a first time length; calculating, based on the calculated first access densities, first variation coefficients of the first access densities; calculating second access densities in respective time periods obtained by dividing a second time period, different from the first time period and identified as a time period in which a response time for the access increases, by a third time length, calculating, based on the calculated second access densities, second variation coefficients of the second access densities in respective time periods; and identifying a cause of the increase in the response time within the second time period based on the result of a test of goodness of fit of distributions of the first and the second variation coefficients.

### CROSS-REFERENCE TO RELATED APPLICATION

This application is based upon and claims the benefit of priority of the prior Japanese Patent Application No. 2016-038084, filed on Feb. 29, 2016, the entire contents of which are incorporated herein by reference.

### FIELD

The embodiment discussed herein is related to a storage medium storing a performance degradation cause estimation program, a performance degradation cause estimating device, and a performance degradation cause estimation method.

### BACKGROUND

Traditionally, there is application software that is executed in a provided cloud environment. In addition, there is a technique for estimating, based on an access frequency and a response time, whether the degradation of performance is caused by application software or by a cloud environment, if a response time for access to the application software by a user increases and the performance is degraded.

As a related technique, there is a technique for determining whether or not defined performance is maintained, based on a model obtained by abstracting constituent elements of a World Wide Web (WWW) site from performance monitoring data on the site and data on changes in access that have been statistically estimated from chronological data on changes in access to the WWW site. In addition, there is a technique for determining an input type and an output type for a temporally high level, a fixed high level, or a fixed low level based on the estimation of the frequency of the input of a process request and the estimation of the frequency of the output of a response and determining, based on a combination of the input and output types, a cause of the occurrence of a process for which a response time exceeds a threshold. Furthermore, there is a technique for measuring a performance value by generating a load while increasing the frequency of access based on a recorded pattern of access to a WWW server and for presenting, as a limit performance value, the frequency of access when the performance value exceeds performance requested for the WWW server. Furthermore, there is a technique for conducting a test of goodness of fit with a probability distribution using both frequency distribution data generated from a request rate or the number of requests transmitted by a load generating device per unit of time and expected frequency distribution data obtained if request rates are distributed in accordance with the desired probability distribution.

Examples of related art are Japanese Laid-open Patent Publications Nos. 2002-268922, 2013-191145, and 2004-318454 and International Publication Pamphlet No. WO2013/145629.

According to the conventional techniques, however, a cause of the degradation of the performance of software may be erroneously estimated. For example, if burst access to software occurs within a part of a certain time period, and the number of times of access is small in another part of the certain time period, the frequency of the access is low and it is erroneously estimated that the degradation of the performance is caused by a cloud environment.

According to an aspect, an object of an embodiment is to provide a storage medium storing a performance degradation cause estimation program, a performance degradation cause estimating device, and a performance degradation cause estimation method that may improve the accuracy of the estimation of a cause of the degradation of the performance of software.

### SUMMARY

According to an aspect of the invention, a performance degradation cause estimation method includes: for each of access types, calculating first access densities in respective time periods obtained by dividing a first time period by a first time length; calculating, based on the calculated first access densities, first variation coefficients of the first access densities; calculating second access densities in respective time periods obtained by dividing a second time period, different from the first time period and identified as a time period in which a response time for the access increases, by a third time length, calculating, based on the calculated second access densities, second variation coefficients of the second access densities in respective time periods; and identifying a cause of the increase in the response time within the second time period based on the result of a test of goodness of fit of distributions of the first and the second variation coefficients.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of operations of a performance degradation cause estimating device according to an embodiment;

FIG. 2 is a diagram illustrating an example of a hardware configuration of the performance degradation cause estimating device;

FIG. 3 is a diagram illustrating a first example in which a cause of the degradation of a response time is erroneously determined;

FIG. 4 is a diagram illustrating a second example in which the cause of the degradation of the response time is erroneously determined;

FIG. 5 is a diagram illustrating a third example in which the cause of the degradation of the response time is erroneously determined;

FIG. 6 is a diagram illustrating an example of a functional configuration of the performance degradation cause estimating device;

FIG. 7 is a diagram illustrating an example of a method of calculating a request process time;

FIG. 8 is a diagram illustrating an example of a method of calculating an access density;

FIG. 9 is a diagram illustrating an example of the correction of the method of calculating an access density;

FIG. 10 is a diagram illustrating an example of the calculation of the average of access densities and a variation coefficient of the access densities;

FIG. 11 is a diagram illustrating a first example of the estimation of a cause of performance degradation based on a test of goodness of fit;

FIG. 12 is a diagram illustrating a second example of the estimation of the cause of the performance degradation based on the test of goodness of fit;

FIG. 13 is a diagram illustrating a first specific example of an analysis time period;

FIG. 14 is a diagram illustrating a second specific example of the analysis time period;

FIG. 15 is a diagram illustrating an example of output of results of estimating causes of performance degradation;

FIG. 16 is a first flowchart of an example of a process of estimating a cause of performance degradation;

FIG. 17 is a second flowchart of the example of the process of estimating the cause of the performance degradation;

FIG. 18 is a third flowchart of the example of the process of estimating the cause of the performance degradation;

FIG. 19 is a diagram illustrating a first example of an effect of the process of estimating the cause of the performance degradation according to the embodiment;

FIG. 20 is a diagram illustrating a second example of the effect of the process of estimating the cause of the performance degradation according to the embodiment;

FIG. 21 is a diagram illustrating a third example of the effect of the process of estimating the cause of the performance degradation according to the embodiment;

FIG. 22 is a diagram illustrating an example of the configuration of a system according to the embodiment;

FIG. 23 is a diagram illustrating an example of details of stored response log data;

FIG. 24 is a diagram illustrating an example of the calculation of request process times;

FIG. 25 is a diagram illustrating an example of the calculation of an access density;

FIG. 26 is a diagram illustrating a first example of the calculation of the average of access densities and a variation coefficient of the access densities;

FIG. 27 is a diagram illustrating a second example of the calculation of the average of the access densities and the variation coefficient of the access densities;

FIG. 28 is a diagram illustrating an example of identifying a cause based on a test of goodness of fit;

FIG. 29 is a diagram illustrating an example of the test of goodness of fit; FIG. 30 is a diagram illustrating another example of the test of goodness of fit; and

FIG. 31 is a diagram illustrating an example of output of results of estimating causes of performance degradation according to an example.

### DESCRIPTION OF EMBODIMENT

Hereinafter, an embodiment of a storage medium storing a performance degradation cause estimation program disclosed herein, a performance degradation cause estimating device disclosed herein, and a performance degradation cause estimation method disclosed herein is described in detail with reference to the accompanying drawings.

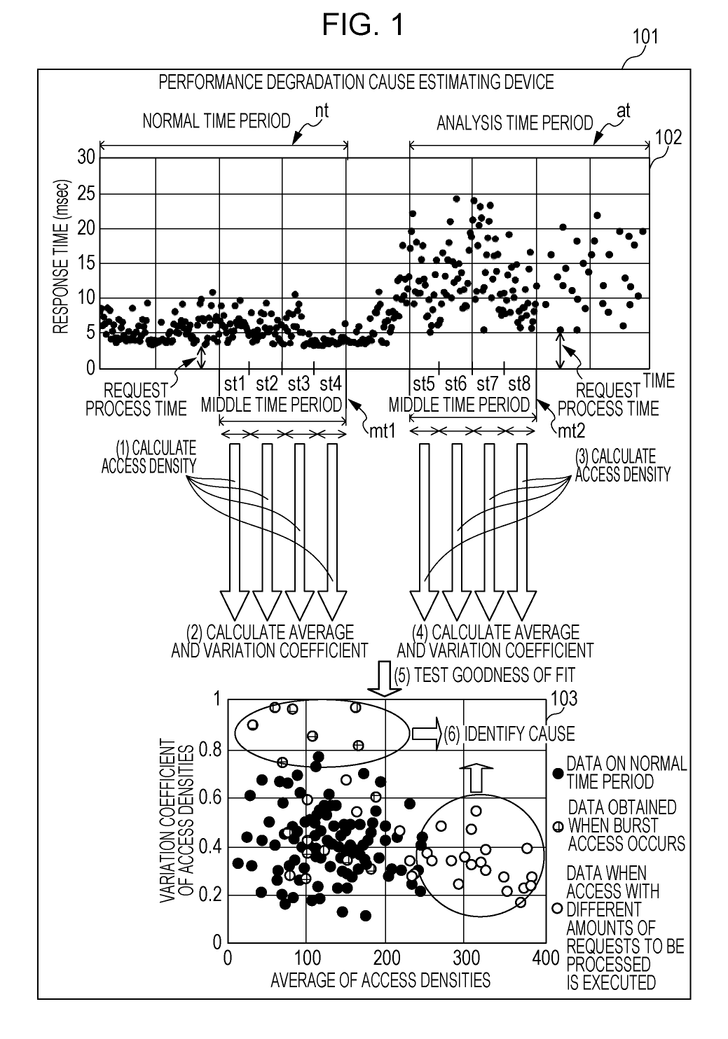

FIG. 1 is a diagram illustrating an example of operations of a performance degradation cause estimating device 101 according to the embodiment. The performance degradation cause estimating device 101 is a server, for example. Specifically, the performance degradation cause estimating device 101 is a computer that identifies a cause of the degradation of the performance of application software executed in a cloud environment. Hereinafter, the application software is referred to as “application”. The application that is executed in the cloud environment is, for example, a web application that provides a web service.

The web application that is executed in the cloud environment is described below. The web application that is to be executed in the cloud environment is executed on a container or a virtual machine (VM) provided by a cloud service. The container is a space separated from groups into which some applications are classified and from applications not belonging to the groups.

When receiving a Hypertext Transfer Protocol (HTTP) request, the web application executes a process defined in the web application and returns the result of the process as a response. A response time from the time when the request is received to the time when the response is returned is a performance index value representative for the web application. For example, if an access load to the web application increases, the increase in the access load may result in an increase in the response time. In the following description, the increase in the response time is referred to as degradation of the response time.

In addition, the process performance of the VM may be reduced due to an effect of the competition of resources in a physical server and a network that form the cloud environment in which the VM is executed. In this case, the reduction in the process performance may result in the degradation of the response time of the web application executed on the VM.

As described above, there are multiple causes of the degradation of the response time of the web application. In addition, different administrators who handle the causes exist in some cases. Specifically, an administrator who manages the cloud environment may be different from an administrator who manages the web application. Thus, if the response time of the web application increases, a cause of the increase is to be appropriately identified. If the cause is not appropriately identified and is notified to an inappropriate administrator, the cause may not be appropriately handled and it may take time to solve the degradation of the response time.

As a technique for estimating a cause of the degradation of a response time, there is a technique for estimating, based on an access frequency and the response time, whether the degradation of the response time is caused by application software or a cloud environment, for example. If the degradation of the response time is caused by the application software, the degradation of the response time may be caused by an increase in an access load to the web application. If the degradation of the response time is caused by the cloud environment, the degradation of the response time may be caused by the competition of resources in the physical server and the network that form the cloud environment. The two causes are referred to as “increase in the access load” and “resource competition”, respectively.

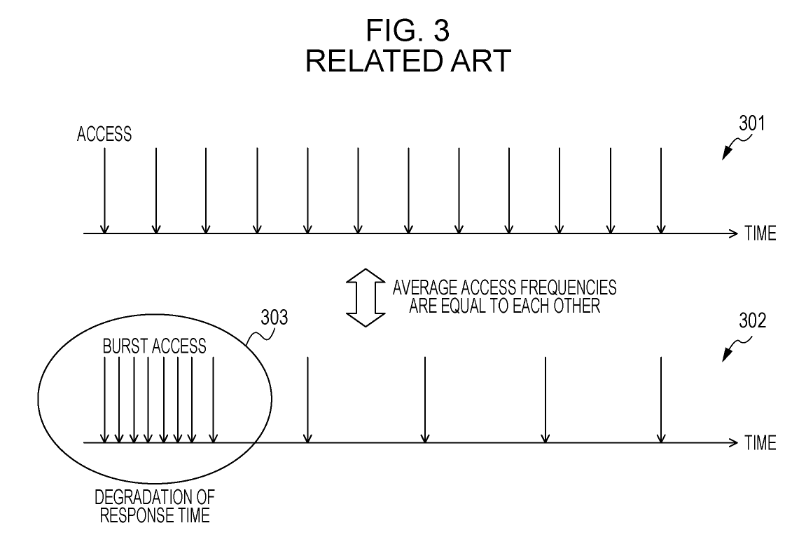

However, in the technique for estimating the cause based on the access frequency and the response time, the cause may be erroneously estimated. For example, if burst access to the software occurs within a part of a certain time period, and the number of times of access is small in another part of the certain time period, the frequency of the access is low and it is erroneously estimated that the degradation of the performance is caused by the resource competition. In addition, if the amount of a request to be processed varies depending on access, the cause of the degradation of the performance may be erroneously estimated. Furthermore, it is considered that whether or not the access load to the web application increases is determined based on the monitoring of performance information such as central processing unit (CPU) utilization of the VM or CPU utilization of the container. However, if the CPU utilization is not able to be acquired, the cause of the degradation of the performance may be erroneously estimated. Cases where the cause of the degradation of the performance is erroneously estimated are described with reference to FIGS. 3 to 5.

The embodiment describes a method of estimating a cause of the degradation of a response time based on the determination, based on minimum response times for access types, of whether a distribution of variation coefficients of access densities in a normal time period matches a distribution of variation coefficients of access densities in an analysis time period. A variation coefficient of access densities is the ratio of the standard deviation to the mean and indicates a variation in a distribution of the access densities. In the embodiment, a cause of the degradation of a response time may be estimated based on the determination, based on the minimum response times for the access types, of whether a distribution of averages of the access densities in the normal time period matches a distribution of averages of the access densities in the analysis time period. This case is also described below with reference to FIG. 1.

Each of the access types is a combination of a request process or a request to the web application and a response result or the result of the request process. For example, access to different uniform resource locators (URLs) as request processes is of different access types. If access to the same URL is executed and response results are different, the access to the same URL is of different access types.

In addition, an access density of each access type is a value obtained by summing values obtained by multiplying the numbers of appearances of the access type by a minimum response time for the access type. A minimum response time for each access type may be approximated to a process time that is treated as a standard time and does not include a delay by burst access and a delay by the resource competition. Hereinafter, a minimum response time for access is referred to as a “request process time” in some cases.

The performance degradation cause estimating device 101 illustrated in FIG. 1 stores response times for access of multiple access types to the web application. A graph 102 illustrated in FIG. 1 indicates response times for access of one type among response times for access that are stored in the performance degradation cause estimating device 101. The abscissa of the graph 102 indicates times when access requests are received, while the ordinate of the graph 102 indicates response times for the access.

As indicated by (1) in FIG. 1, the performance degradation cause estimating device 101 calculates access densities corresponding to short time periods st obtained by dividing a normal time period nt that is a first time period by a first time length. In the example illustrated in FIG. 1, the performance degradation cause estimating device 101 calculates access densities of short time periods st1 to st4 included in the normal time period nt, for example. Regarding access executed in the short time periods st, times when access requests are received are included in the short time periods st. Alternatively, regarding the access executed in the short time periods st, times when responses to the access are returned may be included in the short time periods st.

As indicated by (2) in FIG. 1, the performance degradation cause estimating device 101 calculates, based on the access densities of the short time periods st, variation coefficients of access densities corresponding to middle time periods mt obtained by dividing the normal time period nt by a second time length that is longer than the first time length. In addition, the performance degradation cause estimating device 101 calculates, based on the access densities corresponding to the short time periods st, averages of access densities corresponding to the middle time periods mt included in the normal time periods nt. In the example illustrated in FIG. 1, the short time periods st1 to st4 are included in a middle time period mt1. Thus, the performance degradation cause estimating device 101 calculates, from the access densities corresponding to the short time periods st1 to st4, the average of access densities of the middle time period mt1 and a variation coefficient of the access densities of the middle time period mt1.

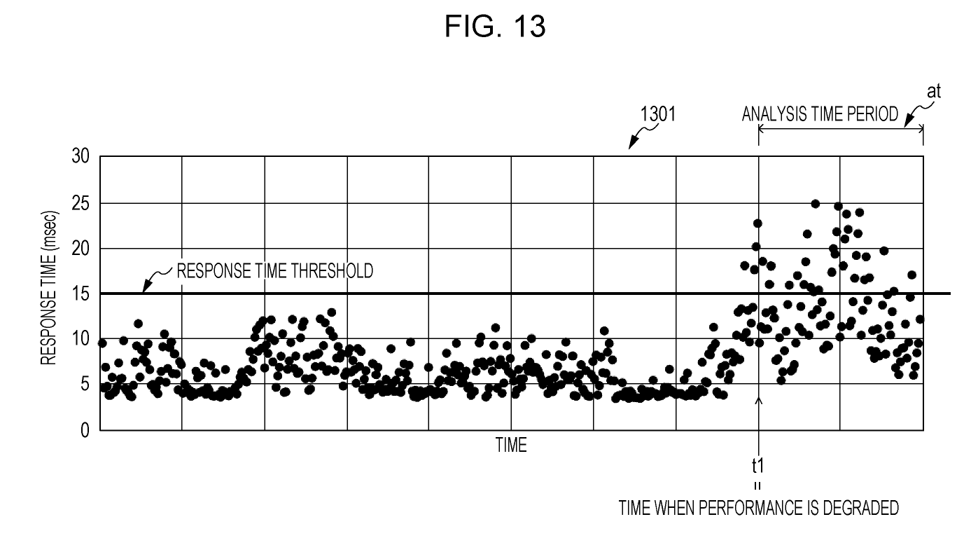

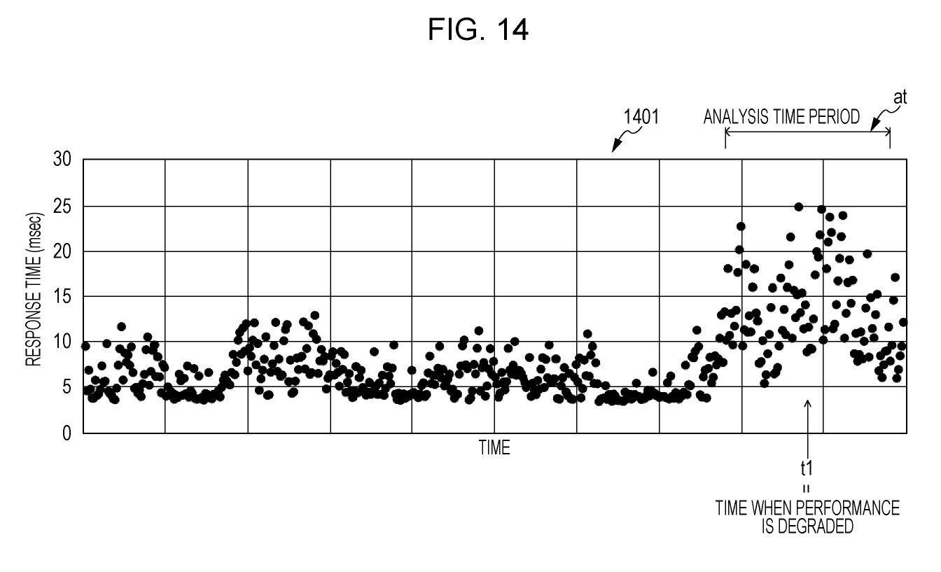

As indicated by (3) in FIG. 1, the performance degradation cause estimating device 101 calculates access densities corresponding to short time periods st obtained by dividing, by a third time length, an analysis time period at that is a second time period identified as a time period in which a response time has increased. It is preferable that the third time length be equal to the first time length. For example, the first and third time lengths are 1 second, for example. An example of identifying the analysis time period at is described with reference to FIGS. 13 and 14. In the example illustrated in FIG. 1, the performance degradation cause estimating device 101 calculates access densities of short time periods st5 to st8 included in the analysis time period at, for example.

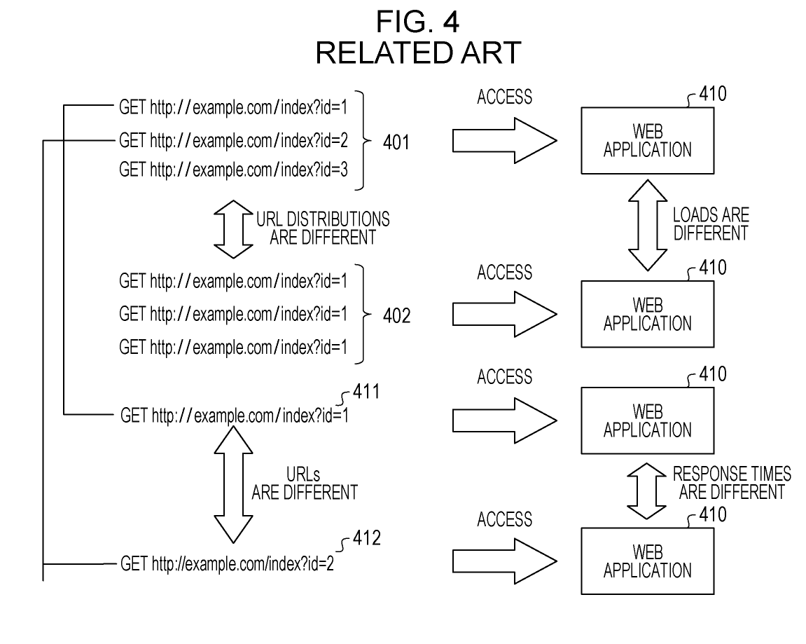

As indicated by (4) in FIG. 4, the performance degradation cause estimating device 101 calculates, based on the access densities of the short time periods st, variation coefficients of access densities corresponding to middle time periods mt obtained by dividing the analysis time period at by a fourth time length that is longer than the third time length. It is preferable that the fourth time length be equal to the second time length. For example, the second and fourth time lengths are 10 seconds. In addition, the performance degradation cause estimating device 101 calculates, based on the access densities corresponding to the short time periods st, averages of access densities corresponding to the middle time periods mt included in the analysis time period at. In the example illustrated in FIG. 1, the short time periods st5 to st8 are included in a middle time period mt2. Thus, the performance degradation cause estimating device 101 calculates, from the access densities corresponding to the short time periods st5 to st8, the average of access densities corresponding to the middle time period mt2 and a variation coefficient of the access densities corresponding to the middle time period mt2.

As indicated by (5) in FIG. 1, the performance degradation cause estimating device 101 conducts a test of goodness of fit of a distribution of the variation coefficients of the access densities of the middle time periods included in the normal time period nt and a distribution of the variation coefficients of the access densities of the middle time periods included in the analysis time period at. The performance degradation cause estimating device 101 may conduct a test of goodness of fit of a distribution of the averages of the access densities of the middle time periods included in the normal time period nt and a distribution of the averages of the access densities of the middle time periods included in the analysis time period at. It is preferable that each of the tests of goodness of fit be the Kolmogorov-Smirnov (K-S) test. By conducting the test of goodness of fit of the distributions of the variation coefficients, the test result that indicates whether or not the two distributions match each other is obtained. By the conducting the test of goodness of fit of the distributions of the averages, the test result that indicates whether or not the two distributions match each other is obtained.

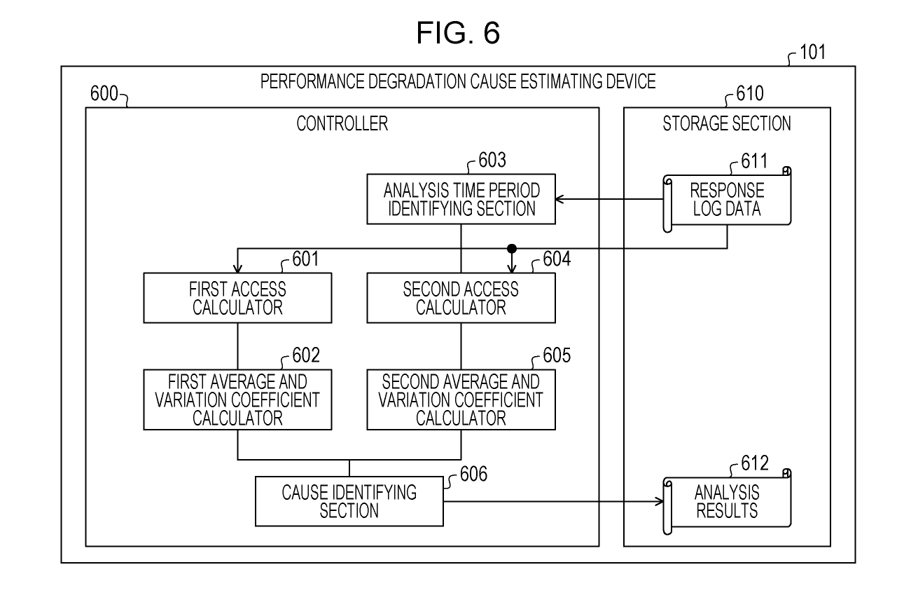

As indicated by (6) in FIG. 6, the performance degradation cause estimating device 101 identifies, based on the test result, a cause of the degradation of the response time within the analysis time period at. In FIG. 1, relationships between variation coefficients of access densities and averages of the access densities are indicated by a graph 103. The abscissa of the graph 103 indicates the average of access densities, while the ordinate of the graph 103 indicates a variation coefficient of the access densities. Points illustrated in black are data on the normal time period nt. Hatched points are data obtained when burst access occurs within the analysis time period at. Points illustrated in white are data obtained when access with different amounts of requests to be processed is executed within the analysis time period at.

As indicated by the graph 103, if burst access occurs, a variation coefficient of access densities increases and the test result indicates that the distribution of the variation coefficients of the access densities in the normal time period nt does not match the distribution of the variation coefficients of the access densities in the analysis time period at. If the test result indicates that the two distributions do not match, the performance degradation cause estimating device 101 identifies that the degradation of the response time is caused by an increase in the access load. Specifically, the performance degradation cause estimating device 101 may identify that the degradation of the response time is caused by a burst increase in the access load.

In addition, as indicated by the graph 103, if access with different amounts of requests to be processed is executed, the average of access densities increases and the test result indicates that the distribution of the averages of the access densities in the normal time period nt does not match the distribution of the averages of the access densities in the analysis time period at. If the test result indicates that the distributions do not match, the performance degradation cause estimating device 101 identifies that the degradation of the response time is caused by an increase in the access load. Specifically, the performance degradation cause estimating device 101 may identify that the degradation of the response time is caused by an average increase in the access load.

In this manner, the performance degradation cause estimating device 101 identifies the cause of the degradation of the response time from the result of the test of goodness of fit of the distributions of the variation coefficients of the access densities, thereby may reflect the burst access in the variation coefficients of the access densities and improve the accuracy of the estimation. In addition, the performance degradation cause estimating device 101 identifies the cause of the degradation of the response time from the result of the test of goodness of fit of the distributions of the averages of the access densities, thereby may reflect the increase in the amount of requests to be processed in the averages of the access densities, and may improve the accuracy of the estimation.

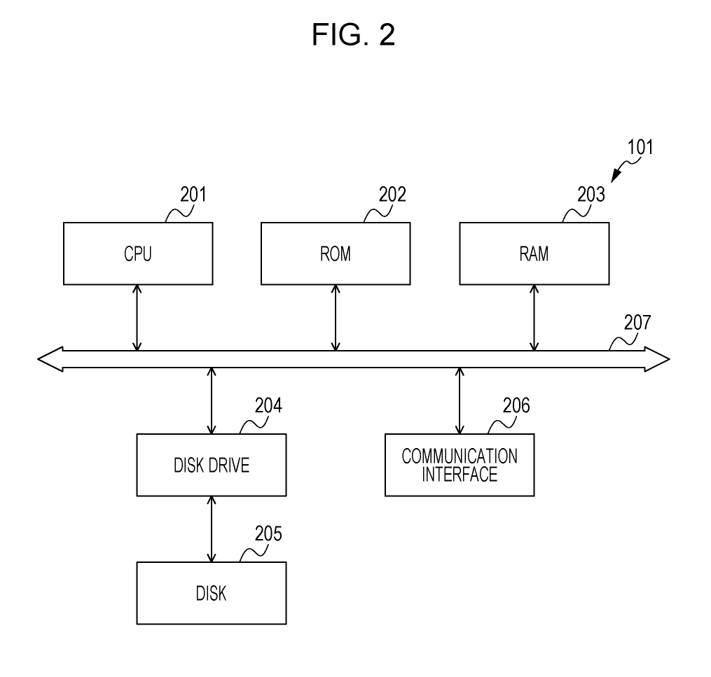

In the description of FIG. 1, the web application that provides the web service is a target to be analyzed in the embodiment. The target may be arbitrary software as long as the software is executed on a cloud service and receives access from an external and returns a response. The target described in the embodiment may be the one web application or may be multiple web applications. Next, a hardware configuration of the performance degradation cause estimating device 101 is describe with reference to FIG. 2.

FIG. 2 is a diagram illustrating an example of the hardware configuration of the performance degradation cause estimating device 101. In FIG. 2, the performance degradation cause estimating device 101 includes a CPU 201, a read-only memory (ROM) 202, and a random access memory (RAM) 203. In addition, the performance degradation cause estimating device 101 includes a disk drive 204, a disk 205, and a communication interface 206. The CPU 201, the ROM 202, the RAM 203, the disk drive 204, and the communication interface 206 are connected to each other via a bus 207.

The CPU 201 is an arithmetic processing device that controls the overall performance degradation cause estimating device 101. The CPU 201 may include multiple processor cores.

The ROM 202 is a nonvolatile memory storing programs such as a boot program. The RAM 203 is a volatile memory to be used as a work area of the CPU 201.

The disk drive 204 is a control device that controls reading and writing of data from and in the disk 205 in accordance with control by the CPU 201. As the disk drive 204, a magnetic disk drive, an optical disc drive, a solid state drive, or the like may be used, for example. The disk 205 is a nonvolatile memory for storing data written in accordance with control by the disk drive 204. For example, if the disk drive 204 is a magnetic disk drive, a magnetic disk may be used as the disk 205. If the disk drive 204 is an optical disc drive, an optical disc may be used as the disk 205. If the disk drive 204 is a solid state drive, a semiconductor memory with semiconductor elements may be used as the disk 205.

The communication interface 206 serves as an interface between the inside of the performance degradation cause estimating device 101 and a network or the like and is a control device that controls input and output of data from and to another device. Specifically, the communication interface 206 is connected to the other device via a communication line and the network or the like. As the communication interface 206, a modem, a local area network (LAN) adapter, or the like may be used, for example.

In a case where an administrator of the performance degradation cause estimating device 101 directly operates the performance degradation cause estimating device 101, the performance degradation cause estimating device 101 may include hardware such as a display, a keyboard, and a mouse.

Next, three examples in which a cause of the degradation of a response time is erroneously determined are described with reference to FIGS. 3 to 5.

FIG. 3 is a diagram illustrating the first example in which the cause of the degradation of the response time is erroneously determined. The first example indicates a case where the response time is degraded due to burst access. On the upper side of the FIG. 3, a graph 301 indicates the trend of uniform access that does not include burst access. On the lower side of FIG. 3, a graph 302 indicates the trend of access that includes burst access. The two trends of the access that are indicated by the graphs 301 and 302 indicate that average access frequencies are equal to each other and that an average response time in the case indicated by the graph 302 is longer than an average response time in the case indicated by the graph 301.

Specifically, burst access and resource competition occur within a short time period indicated in an ellipse 303 in FIG. 3. In the example illustrated in FIG. 3, if the determination is made using the average access frequencies, the average access frequencies are equal to each other and it is not determined that the degradation of the response time is caused by an increase in an access load to the web application.

FIG. 4 is a diagram illustrating the second example in which the cause of the degradation of the response time is erroneously determined. The second example indicates a case where the response time is degraded due to the difference between access types. Access groups 401 and 402 are described with reference to FIG. 4. Since access is executed three times in each of the access groups 401 and 402, average access frequencies of the access groups 401 and 402 are equal to each other. However, since different URLs are accessed in the access group 401, different request processes are executed for the access group 401. Accordingly, the access of different types is executed in the access group 401. Thus, even if the average access frequencies of the access groups 401 and 402 are equal to each other, a load applied to a web application 410 illustrated in FIG. 4 due to the access group 401 is different from a load applied to the web application 410 due to the access group 402. Hereinafter, the fact that one or more URLs accessed in an access group are different from one or more URLs accessed in a next access group is referred to as a “change in an URL distribution”. A URL distribution accessed in the access group 401 is different from a URL distribution accessed in the access group 402.

The access group 401 is described below in detail. Since a URL accessed by access 411 included in the access group 401 is different from a URL accessed by access 412 included in the access group 401, a request process executed for the access 411 is different from a request process executed for the access 412, and the types of the access 411 and 412 are different from each other. Response times for the access of the different types are different from each other. Specifically, in the example illustrated in FIG. 4, when receiving the access 411, the web application 410 executes a process identified by id=1. When receiving the access 412, the web application 410 executes a process identified by id=2. Thus, the processes are different from each other and the response times for the access of the different types are different from each other. When the change in the URL distribution occurs in the example illustrated in FIG. 4, and the determination is made using the average access frequencies, the average access frequencies are equal to each other and it is not determined that the degradation of the response time is caused by an increase in an access load to the web application.

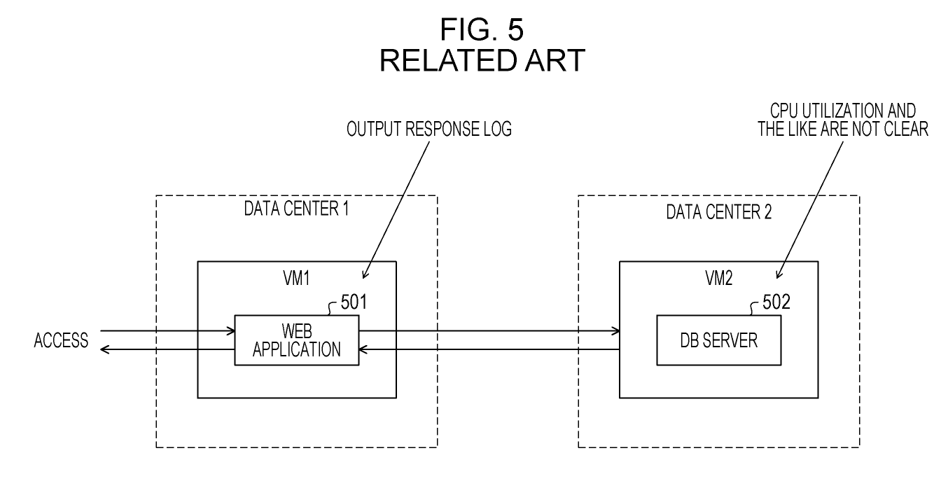

FIG. 5 is a diagram illustrating the third example in which the cause of the degradation of the response time is erroneously determined. The third example indicates a case where external access to another server is executed in response to received access. In this case, a server that received the access does not acquire performance information such as CPU utilization of the other server. Thus, the server that received the access only monitors a response time from the other server and estimates a load state of the other server, and the cause of the degradation of the response time may be erroneously determined.

In the example illustrated in FIG. 5, a VM 1 is executed on a computer within a data center 1, and a web application 501 is executed on the VM 1. In addition, a VM 2 is executed on a computer within a data center 2, and a database (DB) server 502 is executed on the VM 2. In the example illustrated in FIG. 5, even if a response time for access to the web application 501 is degraded, the computer within the data center 1 does not acquire performance information such as CPU utilization of the computer executing the VM 2 and only monitors a response time from the VM 2 and estimates a load state.

Regarding the examples in which the cause of the degradation of the response time is erroneously determined and that are described with reference to FIGS. 3 to 5, an example of a functional configuration for suppressing erroneous determination is described with reference to FIG. 6.

Example of Functional Configuration of Performance Degradation Cause Estimating Device 101

FIG. 6 is a diagram illustrating the example of the functional configuration of the performance degradation cause estimating device 101. The performance degradation cause estimating device 101 includes a controller 600. The controller 600 includes a first access calculator 601, a first average and variation coefficient calculator 602, an analysis time period identifying section 603, a second access calculator 604, a second average and variation coefficient calculator 605, and a cause identifying section 606. When the CPU 201 executes a program stored in a storage device, the controller 600 achieves functions of the sections 601 to 606. The storage device is the ROM 202, the RAM 203, the disk 205, or the like, for example. Results of processes executed by the sections 601 to 606 are stored in a register of the CPU 301, a cache memory of the CPU 301, the RAM 203, or the like.

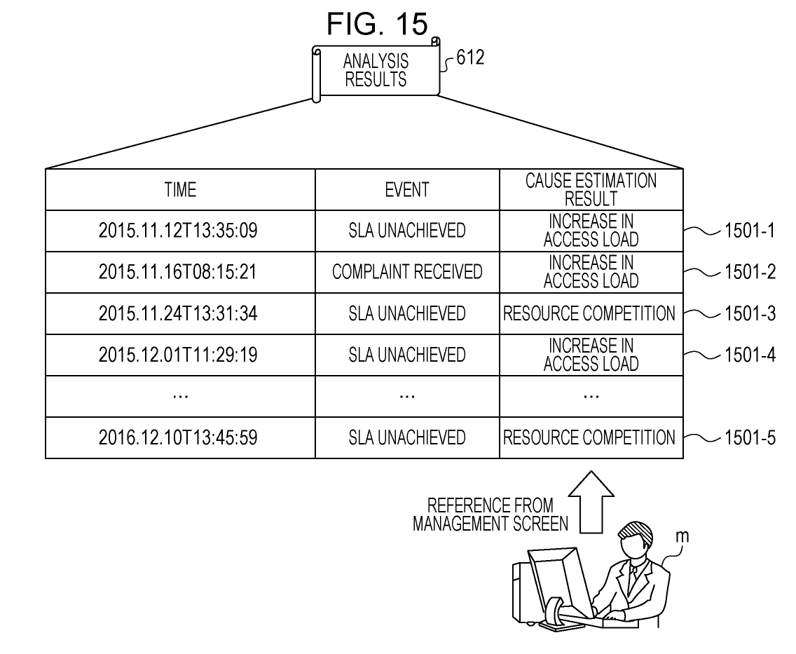

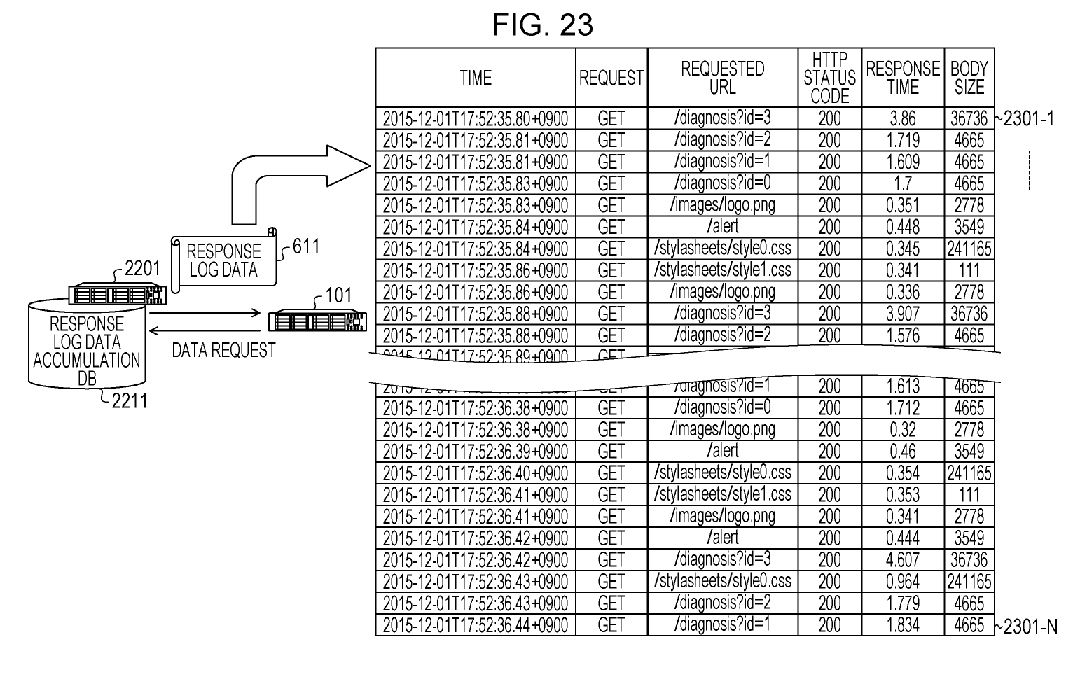

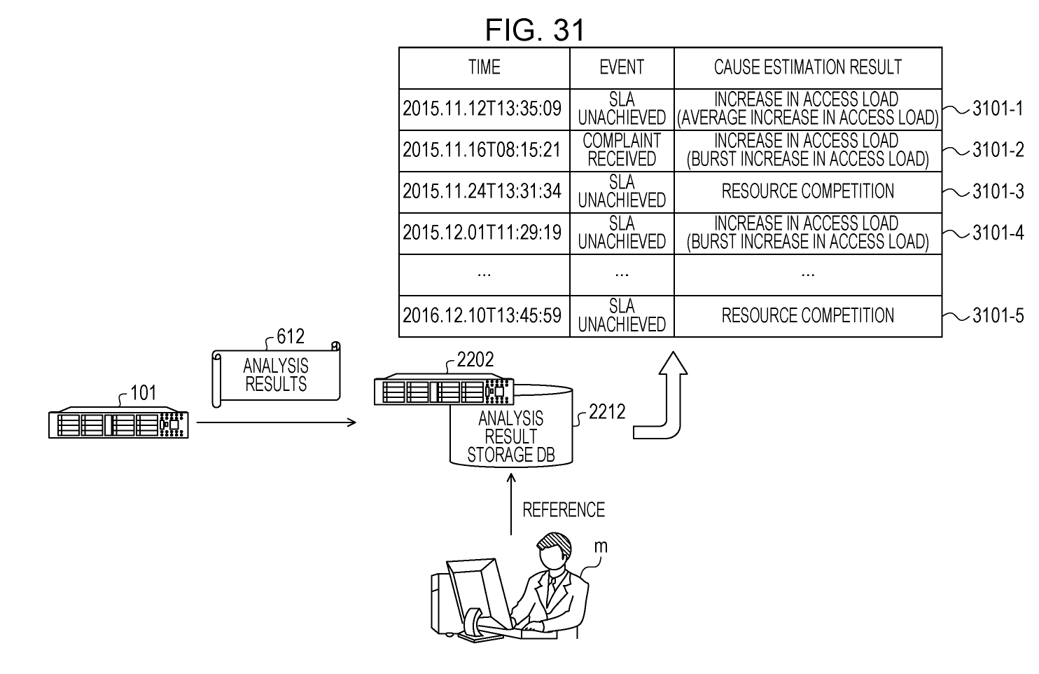

The performance degradation cause estimating device 101 is able to access a storage section 610. The storage section 610 is the RAM 203, the disk 205, or the like. Response log data 611 and analysis results 612 are included in the storage section 610. The response log data 611 stores response times for access of the multiple types. An example of details of the stored response log data 611 is illustrated in FIG. 23. The analysis results 612 store causes of the degradation of the response times. Examples of details of the stored analysis results 612 are illustrated in FIGS. 15 and 31.

The first access calculator 601 references the response log data 611 and calculates the access densities corresponding to the short time periods st included in the normal time period nt. For example, the first access calculator 601 calculates the access densities corresponding to the short time periods st according to the following Equation (1).

An access density corresponding to a short time period st=Σ (the number of appearances of an access type)×(a request process time for the access type) (1)

The first average and variation coefficient calculator 602 calculates, based on the access densities calculated by the first access calculator 601 and corresponding to the short time periods st, the variation coefficients corresponding to the middle time periods mt included in the normal time period nt. In addition, the first average and variation coefficient calculator 602 may calculate, based on the access densities corresponding to the short time periods st, the averages corresponding to the middle time periods mt included in the normal time period nt.

The analysis time period identifying section 603 identifies the analysis time period at based on the time when a response time for access exceeds a predetermined threshold. For example, the analysis time period identifying section 603 identifies, as the analysis time period at, a time period of 10 minutes after the response time for the access exceeds the predetermined threshold. The length of the analysis time period at may be equal to the length of the normal time period nt or different from the length of the normal time period nt. The predetermined threshold is a value specified by the administrator of the application to be analyzed. Alternatively, the predetermined threshold may be based on a service level agreement (SLA) defined for each URL in advance.

The analysis time period identifying section 603 may identify the analysis time period at based on the time when a complaint has arisen from a user of the web application. For example, when receiving, from a computer operated by the user of the web application, information indicating the complaint and information indicating the time when the complaint has arisen, the analysis time period identifying section 603 identifies, as the analysis time period at, time periods of 5 minutes before and after the complaint has arisen. If the analysis time period identifying section 603 receives the information indicating the complaint but does not receive the time when the complaint has arisen, the analysis time period identifying section 603 may treat, as the time when the complaint has arisen, the time when the analysis time period identifying section 603 receives the information indicating the complaint.

The second access calculator 604 references the response log data 611 and calculates the access densities corresponding to the short time periods st included in the analysis time periods at. The second average and variation coefficient calculator 605 calculates, based on the access densities calculated by the second access calculator 604 and corresponding to the short time periods st, the variation coefficients corresponding to the middle time periods mt included in the analysis time period at. In addition, the second average and variation coefficient calculator 605 may calculate, based on the access densities corresponding to the short time periods st, the averages corresponding to the middle time periods mt included in the analysis time period at.

The cause identifying section 606 identifies the cause of the degradation of the response time within the analysis time period at based on the result of the test of goodness of fit of the distributions of the variation coefficients corresponding to the middle time periods mt included in the normal time period nt and the analysis time periods at. In addition, the cause identifying section 606 may identify the cause of the degradation of the response time within the analysis time period at based on the result of the test of goodness of fit of the distributions of the averages corresponding to the middle time periods mt included in the normal time period nt and the analysis time periods at.

For example, if the result of the test related to the distributions of the variation coefficients indicates that the distributions are the same, and the result of the test related to the distributions of the averages indicates that the distributions are the same, the cause identifying section 606 identifies that the degradation of the response time within the analysis time period at is caused by the resource competition. In addition, if the result of the test related to the distributions of the variation coefficients indicates that the distributions are different from each other or if the result of the test related to the distributions of the averages indicates that the distributions are different from each other, the cause identifying section 606 identifies that the degradation of the response time within the analysis time period at is caused by an increase in the access load.

If the result of the test related to the distributions of the variation coefficients indicates that the distributions are different from each other, the cause identifying section 606 may identify that the degradation of the response time within the analysis time period at is caused by a burst increase in the access load. If the result of the test related to the distributions of the averages indicates that the distributions are different from each other, the cause identifying section 606 may identify that the degradation of the response time within the analysis time period at is caused by an average increase in the access load.

The cause identifying section 606 causes the identified result to be stored in the analysis results 612. If the cause identifying section 606 identifies that the degradation is caused by the resource competition, the cause identifying section 606 may notify a computer operated by the administrator of the cloud environment of the identified result. If the cause identifying section 606 identifies that the degradation is caused by the increase in the access load, the cause identifying section 606 may notify a computer operated by the administrator of the application to be analyzed of the identified result.

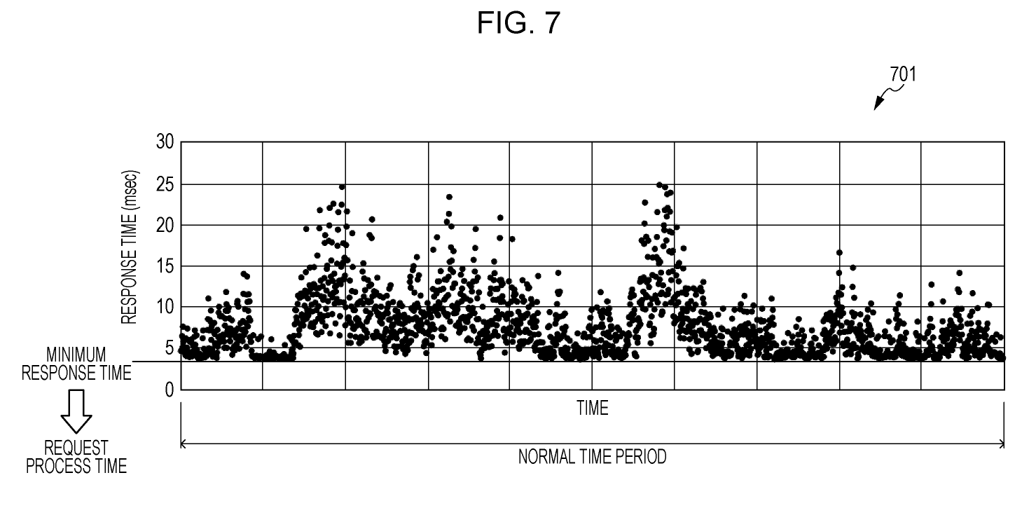

Next, details of the functions included in the controller 600 are described with reference to FIGS. 7 to 15.

FIG. 7 is a diagram illustrating an example of a method of calculating a request process time. The performance degradation cause estimating device 101 stores a minimum response time or a request process time for each of the access types. The minimum response times may be treated as process times that serve as standard times and do not include delays of the access of the multiple types.

A graph 701 indicated in the example of FIG. 7 indicates response times for access of a certain single type within the normal time period nt. The abscissa of the graph 701 indicates time, while the ordinate of the graph 701 indicates a response time. Points included in the graph 701 indicate times when the access is executed and the response times for the access. As indicated by the points included in the graph 701, the minimum response time among the response times for the access of the certain single type is approximately 4 milliseconds (msec). Thus, the performance degradation cause estimating device 101 stores, as approximately 4 msec, a request process time for the access of the certain single type. The minimum response times for the access types may be set to a fixed value. However, the minimum response time among response times for access of a single type may vary depending on a situation. It is, therefore, preferable that the minimum response times be measured within time periods nt in order to accurately execute the estimation.

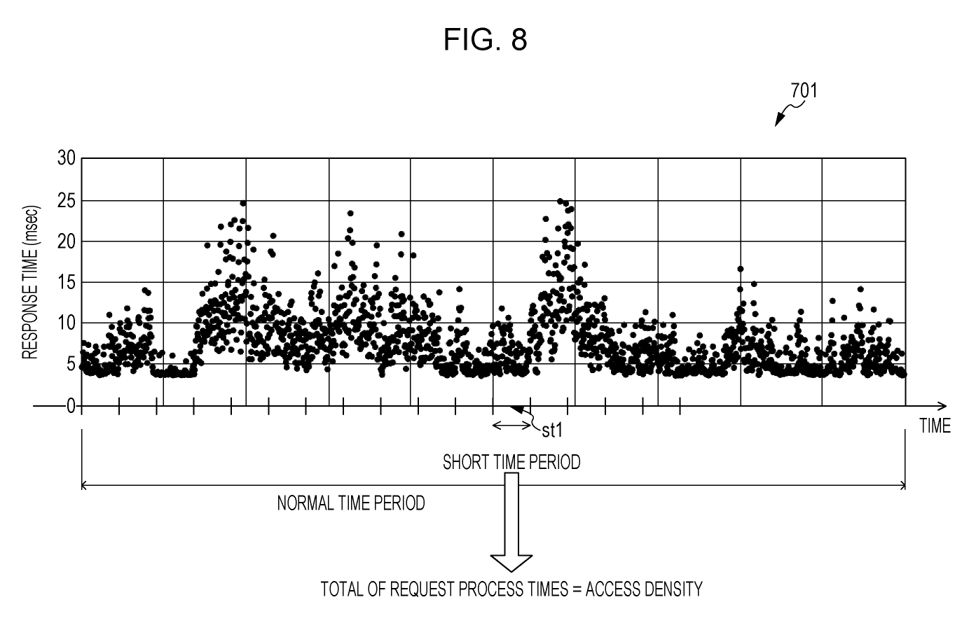

FIG. 8 is a diagram illustrating an example of a method of calculating an access density. The performance degradation cause estimating device 101 calculates an access density for each of the short time periods that are shorter than the normal time period. The total of request process times is treated as an access density.

For example, the performance degradation cause estimating device 101 treats an access density of a short time period st1 illustrated in FIG. 8 as a value obtained by multiplying the number of times of access in the short time period st1 by a request process time.

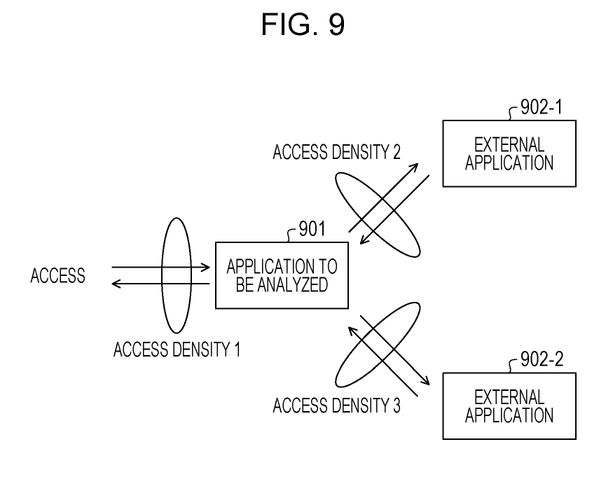

FIG. 9 is a diagram illustrating an example of the correction of the method of calculating an access density. If the application to be analyzed uses a service of an external application or uses, for example, an external application programming interface (API), the performance degradation cause estimating device 101 calculates all densities of access to the external application and subtracts the calculated densities from the density of access to the application to be analyzed.

For example, in FIG. 9, an application 901 to be analyzed uses external applications 902-1 and 902-2. In this case, the performance degradation cause estimating device 101 uses the following Equation (2) to calculate the density of access to the application 901 to be analyzed.

The density of the access to the application 901 to be analyzed =an access density 1−an access density 2−an access density 3 (2)

The access densities 1 to 3 are calculated in accordance with the method described with reference to FIG. 8. The access density 1 is the density, calculated in accordance with the method described with reference to FIG. 8, of access to the application 901 to be analyzed. The access densities 2 and 3 are the densities, calculated in accordance with the method described with reference to FIG. 8, of access to the external applications 902-1 and 902-2. If the performance of any of the external applications 902-1 and 902-2 is reduced, the performance degradation cause estimating device 101 monitors a corresponding one of the access densities 2 and 3 and thereby may detect the reduction in the performance.

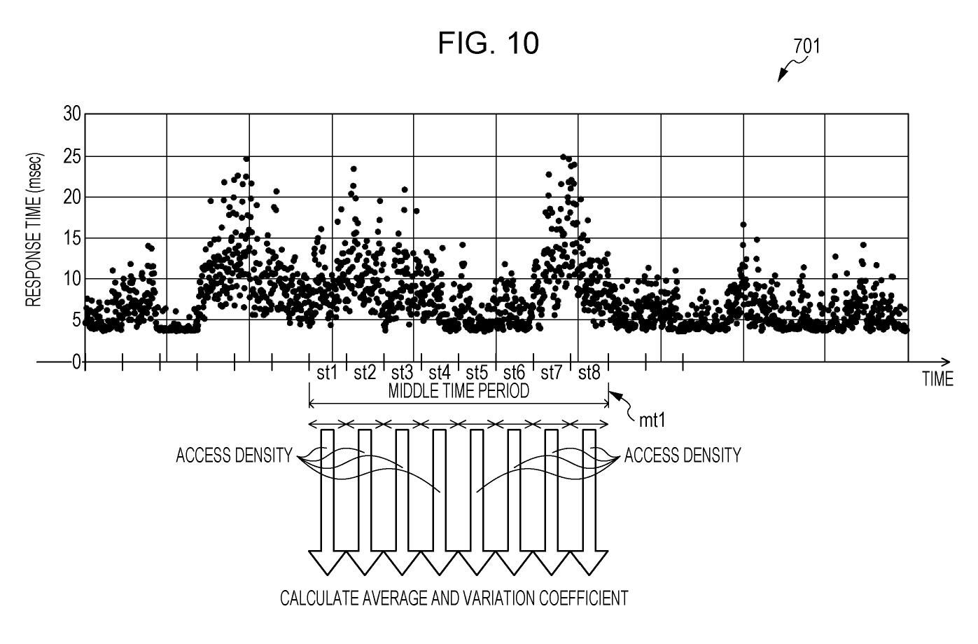

FIG. 10 is a diagram illustrating an example of the calculation of the average of access densities and a variation coefficient of the access densities. The performance degradation cause estimating device 101 calculates, from the access densities corresponding to the short time periods included in the middle time periods, the average of access densities corresponding to each of the middle time periods and a variation coefficient of access densities corresponding to each of the middle time periods.

For example, the performance degradation cause estimating device 101 calculates, from access densities of short time periods st1 to st8 illustrated in FIG. 10, the average of access densities of a middle time period mt1 illustrated in FIG. 10 and a variation coefficient of the access densities of the middle time period mt1.

In the same manner as described above, the performance degradation cause estimating device 101 calculates averages of access densities in the analysis time period at and variation coefficients of the access densities in the analysis time period at including the time when a response time is degraded.

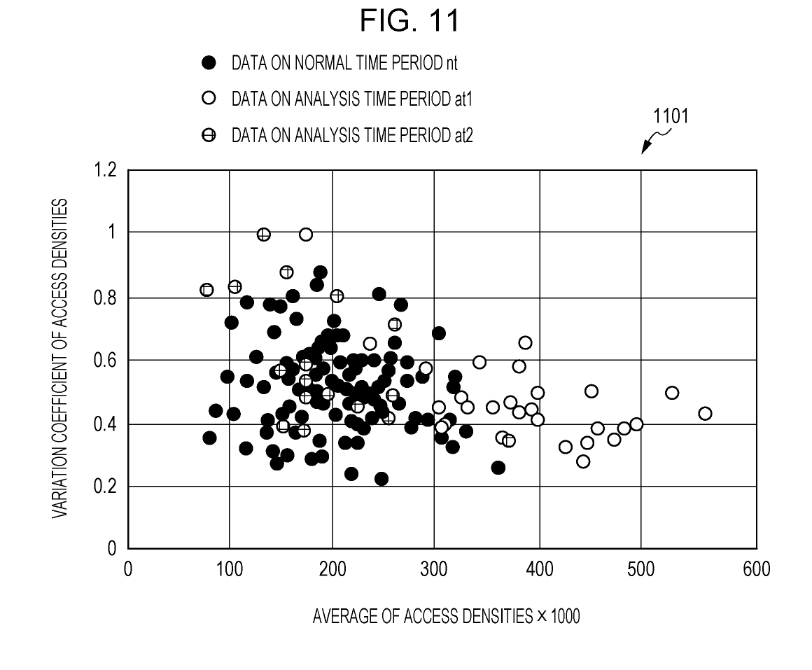

FIG. 11 is a diagram illustrating a first example of the estimation of a cause of performance degradation based on a test of goodness of fit. The performance degradation cause estimating device 101 conducts a test of goodness of fit of distributions of averages of access densities in the normal time period nt and the analysis time period at and determines whether or not the distributions match each other. The performance degradation cause estimating device 101 conducts a test of goodness of fit of distributions of variation coefficients of the access densities in the normal time period nt and the analysis time period at and determines whether or not the distributions match each other.

If the distributions of the averages of the access densities are different from each other, the performance degradation cause estimating device 101 determines that the degradation of the response time is caused by an average increase in the access load. The average increase in the access load is an increase in the access frequency, an increase in the amount of processing for the access.

If the distributions of the variation coefficients of the access densities are different from each other, the performance degradation cause estimating device 101 determines that the degradation of the response time is caused by a burst increase in the access load. If the distributions of the variation coefficients of the access densities are different from each other, a variation in the access densities is large and the performance degradation cause estimating device 101 may estimate that the degradation of the response time is caused by the burst increase in the access load.

If the distributions of the averages of the access densities are the same and the distributions of the variation coefficients of the access densities are the same, the performance degradation cause estimating device 101 determines that the degradation of the response time is caused by the resource competition. If the access load does not change from the access load in a normal state, the degradation of the response time is not caused by an increase in the access load and the performance degradation cause estimating device 101 determines that the degradation of the response time is caused by the resource competition.

A graph 1101 illustrated in FIG. 11 indicates relationships between the averages of the access densities in the normal time period nt, the variation coefficients of the access densities in the normal time period nt, averages of access densities in analysis time periods at1 and at2, and variation coefficients of the access densities in the analysis time periods at1 and at2. The abscissa of the graph 1101 indicates a value obtained by multiplying the average of access densities by 1000, and the ordinate of the graph 1101 indicates a variation coefficient of the access densities. Points illustrated in black indicate data on the normal time period nt. Points illustrated in white indicate data on the analysis time period at1. Hatched points indicate data on the analysis time period at2.

A distribution of the averages of the access densities indicated in the data on the analysis time period at1 is different from a distribution of the averages of the access densities indicated in the data on the normal time period nt. Thus, the performance degradation cause estimating device 101 determines that the degradation of the performance in the analysis time period at1 is caused by the degradation, caused by an average increase in the access load, of a response time.

A distribution of the averages of the access densities indicated in the data on the analysis time period at2 is the same as the distribution of the averages of the access densities indicated in the data on the normal time period nt, and a distribution of the variation coefficients of the access densities indicated in the data on the analysis time period at2 is the same as a distribution of the variation coefficients of the access densities indicated in the data on the normal time period nt. Thus, the performance degradation cause estimating device 101 determines that the degradation of the performance in the analysis time period at2 is caused by the degradation, caused by the resource competition, of the response time.

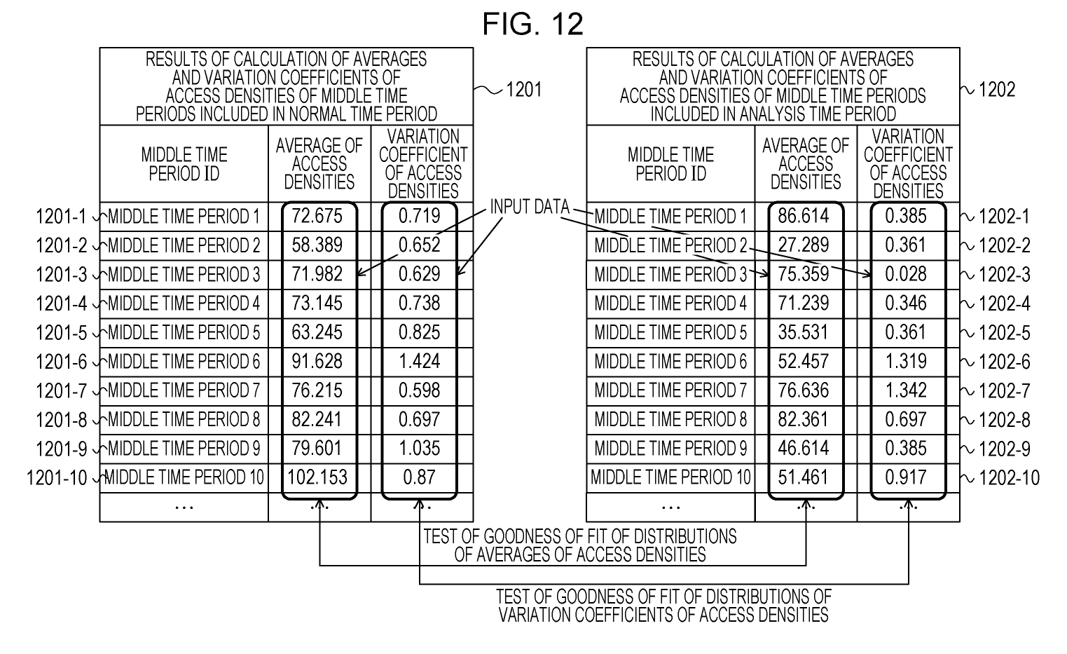

FIG. 12 is a diagram illustrating a second example of the estimation of the cause of the performance degradation based on the test of goodness of fit. Specific values are illustrated in FIG. 12, and the test of goodness of fit is described with reference to FIG. 12. Tables 1201 and 1202 illustrated in FIG. 12 indicate the results of calculating the averages and variation coefficients of the access densities of the middle time periods included in the normal time period nt and the analysis time period at. The table 1201 illustrated in FIG. 12 includes records 1201-1 to 1201-10. The table 1202 illustrated in FIG. 12 includes records 1202-1 to 1202-10.

Each of the tables 1201 and 1202 includes a middle time period identifier (ID) field, an average access density field, and an access density variation coefficient field. In the middle time period ID fields, values identifying the middle time periods are stored. In the average access density fields, the averages of the access densities are stored. In the access density variation coefficient fields, the variation coefficients of the access densities are stored. For example, the record 1201-1 indicates that the average of access densities of a middle time period 1 is 72.675 and that a variation coefficient of the access densities of the middle time period 1 is 0.719.

The performance degradation cause estimating device 101 conducts a test of goodness of fit of values of the average access density field of the table 1201 and values of the average access density field of the table 1202. In addition, the performance degradation cause estimating device 101 conducts a test of goodness of fit of values of the access density variation coefficient field of the table 1201 and values of the access density variation coefficient field of the table 1202. If the performance degradation cause estimating device 101 determines that distributions of the averages of the access densities in the normal time period nt and the analysis time period at are the same and that distributions of the variation coefficients of the access densities in the normal time period nt and the analysis time period at are the same, the performance degradation cause estimating device 101 determines that the degradation of the performance is caused by the degradation, caused by the resource competition, of the response time, as described with reference to FIG. 11. If the performance degradation cause estimating device 101 determines that the distributions of the averages of the densities in the normal time period nt and the analysis time period at are different from each other or that the distributions of the variation coefficients of the densities in the normal time period nt and the analysis time period at are different from each other, the performance degradation cause estimating device 101 determines that the degradation of the performance is caused by the degradation, caused by an increase in the access load, of the response time as illustrated in FIG. 11.

Next, two specific examples of the analysis time period at are described with reference to FIGS. 13 and 14. Specifically, a method of identifying the analysis time period at when an event indicating that an SLA has not been achieved occurs is described with reference to FIG. 13, and a method of identifying the analysis time period at when an event indicating that a complaint has arisen occurs is described with reference to FIG. 14.

FIG. 13 is a diagram illustrating the first specific example of the analysis time period at. The first specific example of the analysis time period at describes a method of identifying that the performance is degraded upon the occurrence of an event indicating that an SLA defined for each URL in advance and related to a response time has not been achieved. An example of the SLA is an SLA indicating that the response time for access whose rate is 99% or higher is suppressed to a response time threshold or shorter. The performance degradation cause estimating device 101 identifies, as the analysis time period at, a time period from a certain time when it is determined that the SLA has not been achieved to the time when a predetermined time period of 5 minutes, 10 minutes, or the like elapses after the certain time.

For example, a graph 1301 illustrated in FIG. 13 indicates response times for access within a certain time period. It is assumed that the response time threshold is set to 15 msec. As indicated in the graph 1301, it is assumed that the performance degradation cause estimating device 101 determines that the SLA has not been achieved at a time t1. In this case, the performance degradation cause estimating device 101 identifies, as the analysis time period at, a time period from the time t1 to the time when the predetermined time period elapses after the time t1.

FIG. 14 is a diagram illustrating the second specific example of the analysis time period at. The second specific example of the analysis time period at describes a method of identifying that the performance is degraded upon the occurrence of an event indicating that a complaint related to the performance has arisen from an external such as the user of the web application. For example, the performance degradation cause estimating device 101 identifies, as the analysis time period at, a time period including the time when the complaint has been received. For example, the performance degradation cause estimating device 101 identifies, as the analysis time period at, time periods of 5 minutes before and after the complaint has been received.

For example, a graph 1401 illustrated in FIG. 14 indicates response times for access within a certain time period. As indicated in the graph 1401, it is assumed that a complaint has arisen at a time t1. In this case, the performance degradation cause estimating device 101 identifies, as the analysis time period at, time periods of 5 minutes before and after the time t1.

FIG. 15 is a diagram illustrating an example of output of results of estimating causes of performance degradation. Analysis results 612 illustrated in FIG. 15 are a table indicating the output results of estimating the causes within analysis time periods at identified by the performance degradation cause estimating device 101 as described with reference to FIGS. 13 and 14. The analysis results 612 illustrated in FIG. 15 include records 1501-1 to 1501-5.

The analysis results 612 include a time field, an event field, and a cause estimation result field. In the time field, values that indicate times when events stored in the event field have been identified are stored. In the event field, characteristic strings that indicate the events triggering the identification of the analysis time periods at described with reference to FIGS. 13 and 14 are stored. In the cause estimation result field, values that indicate the results of estimating the causes are stored. For example, the record 1501-1 indicates that an event indicating that an SLA has not been achieved has occurred at 13:35:09 on Nov. 12, 2015 and that the result of estimating a cause indicates that the degradation of the performance has been caused by an increase in the access load.

An administrator m illustrated in FIG. 15 is the administrator of the web application to be analyzed or the administrator of the cloud environment in which the web application is executed. For example, it is assumed that the administrator m is the administrator of the cloud environment. In this case, the administrator m browses details of the record 1501-2 and notifies the administrator of the web application that the access load has increased, for example. In addition, the administrator m browses details of the record 1501-3 and confirms the assignment of resources to the VM or the container, for example.

Alternatively, it is assumed that the administrator m is the administrator of the web application. In this case, the administrator m browses the details of the record 1501-2 and recognizes that the degradation of the performance is caused by the increase in the access load. Thus, the administrator m confirms the response log data 611 and details of a process of the web application, for example.

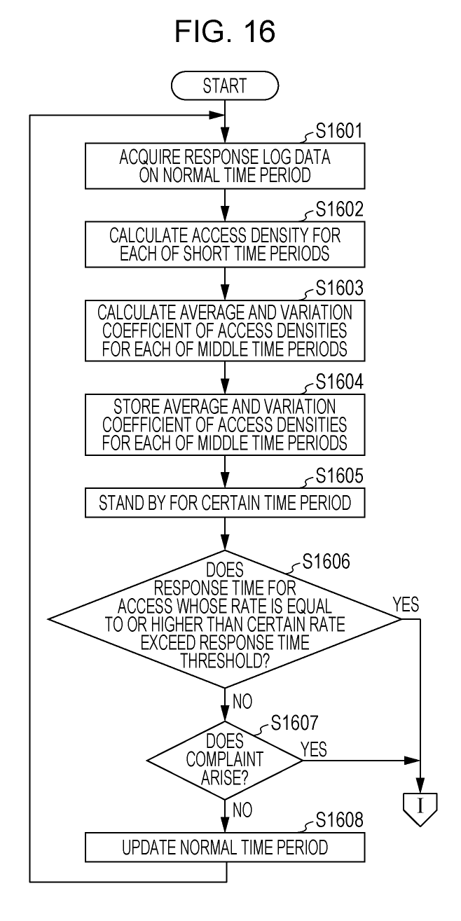

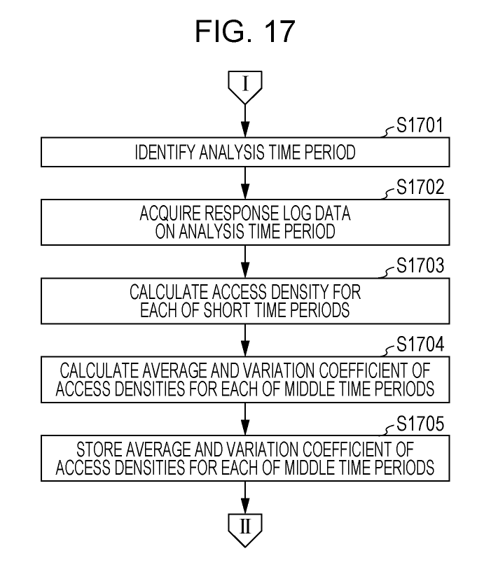

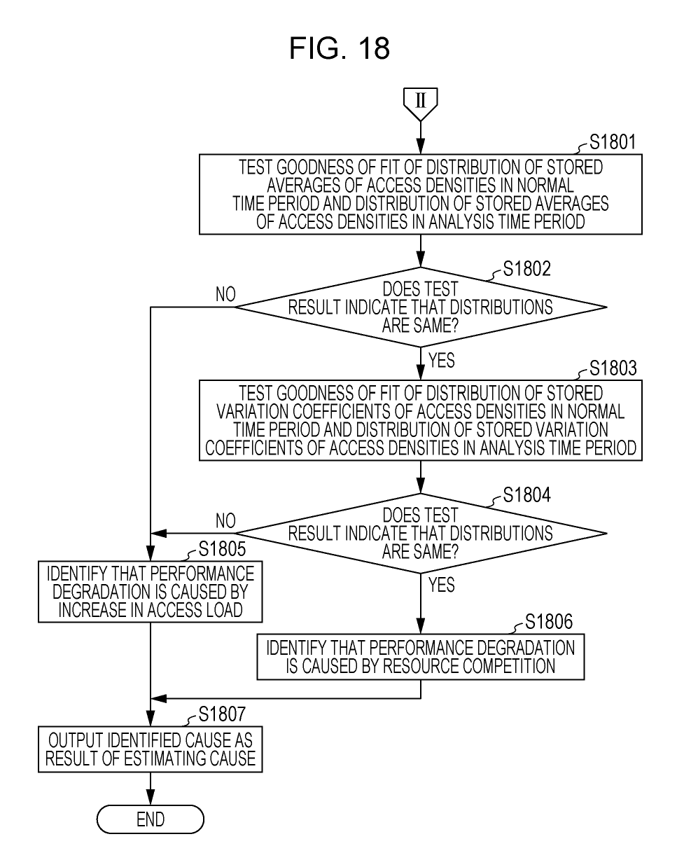

FIG. 16 is a first flowchart of an example of a process of estimating a cause of performance degradation. FIG. 17 is a second flowchart of the example of the process of estimating the cause of the performance degradation. FIG. 18 is a third flowchart of the example of the process of estimating the cause of the performance degradation.

The performance degradation cause estimating device 101 acquires the response log data 611 on the normal time period nt (in step S1601). For example, the performance degradation cause estimating device 101 acquires the response log data 611 on the most recent time period of 10 minutes as the normal time period nt.

Next, the performance degradation cause estimating device 101 calculates an access density for each of the short time periods included in the normal time period nt (in step S1602). Then, the performance degradation cause estimating device 101 calculates an average and variation coefficient of access densities for each of the middle time periods included in the normal time period nt (in step S1603). Then, the performance degradation cause estimating device 101 stores the calculated averages and variation coefficients of the access densities of the middle time periods (in step S1604). If the performance degradation cause estimating device 101 has averages and variation coefficients stored therein, the performance degradation cause estimating device 101 updates the stored averages and variation coefficients to the averages and variation coefficients calculated in step S1604. Then, the performance degradation cause estimating device 101 stands by for a certain time period (in step S1605).

Then, the performance degradation cause estimating device 101 determines whether or not a response time for access whose rate is equal to or higher than a certain rate has exceeded the response time threshold (in step S1606), or, whether or not a number of accesses whose response times exceed the response time threshold has reached the certain rate of the total number of accesses within a certain period. If the response time for the access whose rate is equal to or higher than the certain rate has not exceeded the response time threshold (No in step S1606), the performance degradation cause estimating device 101 determines whether or not a complaint has arisen (in step S1607). If the complaint has not arisen (No step S1607), the performance degradation cause estimating device 101 updates the normal time period (in step S1608).

If the response time for the access whose rate is equal to or higher than the certain rate has exceeded the response time threshold (Yes in step S1606) or if the complaint has arisen (Yes in step S1607), the performance degradation cause estimating device 101 identifies the analysis time period at based on the time when the response time has exceeded the response time threshold or based on the time when the complaint has arisen (in step S1701 illustrated in FIG. 17). Then, the performance degradation cause estimating device 101 acquires the response log data 611 on the analysis time period at (in step S1702). After that, the performance degradation cause estimating device 101 calculates an access density for each of the short time periods included in the analysis time period at (in step S1703). The performance degradation cause estimating device 101 calculates an average and variation coefficient of access densities for each of the middle time periods included in the analysis time period at (in step S1704). Then, the performance degradation cause estimating device 101 stores the calculated averages and variation coefficients of the access densities of the middle time periods (in step S1705).

The performance degradation cause estimating device 101 conducts a test of goodness of fit of a distribution of the stored averages of the access densities in the normal time period nt and a distribution of the stored averages of the access densities in the analysis time period at (in step S1801 illustrated in FIG. 18). The performance degradation cause estimating device 101 determines whether or not the result of the test indicates that the distributions of the stored averages match each other (in step S1802). If the result of the test indicates that the distributions of the stored averages match each other (Yes in step S1802), the performance degradation cause estimating device 101 conducts a test of goodness of fit of a distribution of the stored variation coefficients of the access densities in the normal time period nt and a distribution of the stored variation coefficients of the access densities in the analysis time period at (in step S1803). Then, the performance degradation cause estimating device 101 determines whether or not the result of the test indicates that the distributions of the stored variation coefficients match each other (in step S1804).

If the result of the test does not indicate that the distributions of the stored averages match each other (No in step S1802) or if the result of the test does not indicate that the distributions of the stored variation coefficients match each other (No in step S1804), the performance degradation cause estimating device 101 identifies that the performance degradation is caused by an increase in the access load (in step S1805). In this case, if the answer to step S1802 is No, the performance degradation cause estimating device 101 may identify that the performance degradation is caused by an average increase in the access load. If the answer to step S1804 is No, the performance degradation cause estimating device 101 may identify that the performance degradation is caused by a burst increase in the access load.

If the result of the test indicates that the distributions match each other (Yes in S1804), the performance degradation cause estimating device 101 identifies that the performance degradation is caused by the resource competition (in step S1806). After the termination of the process of step S1805 or S1806, the performance degradation cause estimating device 101 outputs, as the result of estimating the cause, information indicating the cause identified in the process of S1805 or S1806 (in step S1807). Then, the performance degradation cause estimating device 101 terminates the process of estimating the cause of the performance degradation.

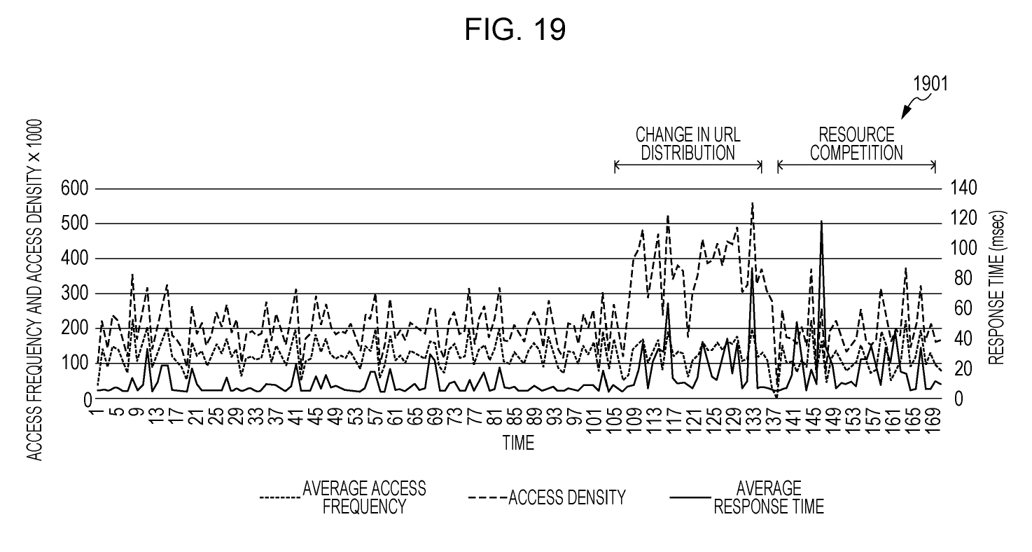

FIG. 19 is a diagram illustrating a first example of an effect of the process of estimating the cause of the performance degradation according to the embodiment. The effect of the process of estimating the cause of the performance degradation according to the embodiment is described using a graph 1901 illustrated in FIG. 19. The graph 1901 indicates an average access frequency, an access density, and an average response time. In the graph 1901, changes in the average access frequency are indicated by a dotted line, changes in the access density are indicated by a broken line, and changes in the average response time are indicated by a solid line.

The abscissa of the graph 1901 indicates time. Specifically, the abscissa of the graph 1901 indicates times obtained by multiplying values by a middle time period of several seconds. For example, if the middle time period is 5 seconds, 169 indicated on the graph 1901 indicates 169×5=845 seconds. The ordinate of the graph 1901 indicates the access frequency, the access density×1000, and the response time.

If a URL distribution is changed, the access density increases as indicated by the graph 1901. Thus, the performance degradation cause estimating device 101 may determine, based on the access density, that the performance degradation is caused by the degradation, caused by an increase in the access load, of the response time. If the URL distribution is changed, the access frequency does not change, but the cause of the performance degradation may be erroneously determined. In the embodiment, erroneous determination may be suppressed by using access densities, and the accuracy of identifying the cause may be improved by using the access densities.

If the resource competition occurs, changes in the access density are the same as or similar to changes in the average access frequency. In the embodiment, therefore, even if the performance degradation is caused by the resource competition, the cause may be determined with similar accuracy to determination to be made using the average access frequency or may be appropriately determined.

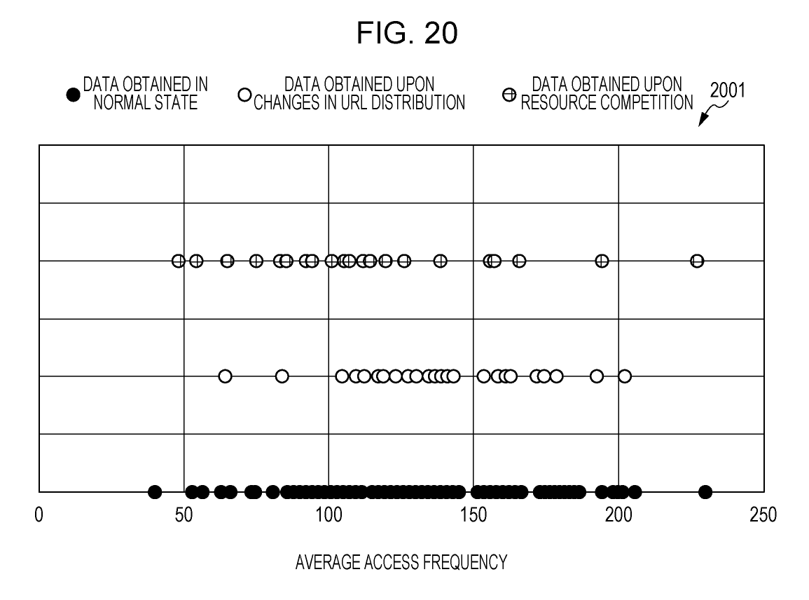

FIG. 20 illustrates a diagram illustrating a second example of the effect of the process of estimating the cause of the performance degradation according to the embodiment. A graph 2001 illustrated in FIG. 20 indicates average access frequencies in the normal state, average access frequencies upon changes in a URL distribution, and average access frequencies upon resource competition. The abscissa of the graph 2001 indicates an average access frequency. Points illustrated in black indicate data obtained in the normal state, points illustrated in white indicate data obtained upon the changes in the URL distribution, and hatched points indicate data obtained upon the resource competition.

As indicated by the graph 2001, in the data obtained upon the changes in the URL distribution and the data obtained upon the resource competition, the average access frequencies do not largely change. Thus, if the determination is made using the average access frequencies, it is determined that the performance degradation is caused by the resource competition upon a change in the URL distribution and upon the resource competition. If the determination is made using the average access frequencies, the determination is erroneously made upon a change in the URL distribution.

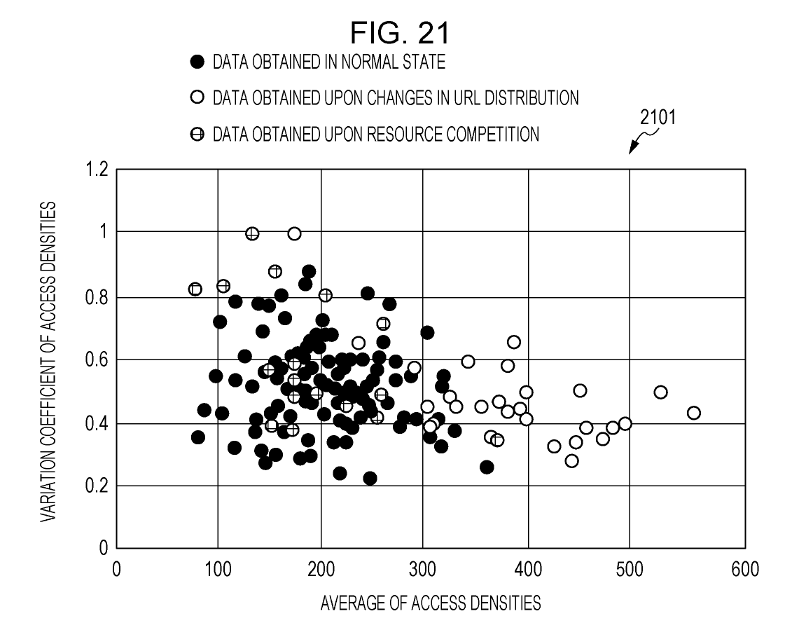

FIG. 21 is a diagram illustrating a third example of the effect of the process of estimating the cause of the performance degradation according to the embodiment. A graph 2101 illustrated in FIG. 21 indicates relationships between averages and variation coefficients of access densities in the normal state, upon changes in the URL distribution, and upon the resource competition. The abscissa of the graph 2101 indicates the average of access densities, while the ordinate of the graph 2101 indicates a variation coefficient of the access densities. Points illustrated in black indicate data obtained in the normal state. Points illustrated in white indicate data obtained upon the changes in the URL distribution. Hatched points indicate data obtained upon the resource competition.

As indicated by the graph 2101, the data obtained upon the changes in the URL distribution indicates that the average of access densities changes due to the changes in the URL distribution. In the embodiment, therefore, the determination is made using access densities, it may be determined that the performance degradation is caused by an increase in the access load upon a change in the URL distribution, and a probability at which the determination may be erroneously determined may be reduced.

### EXAMPLE

Next, as an example, a case where the performance degradation cause estimating device 101 is installed in a system is described below.

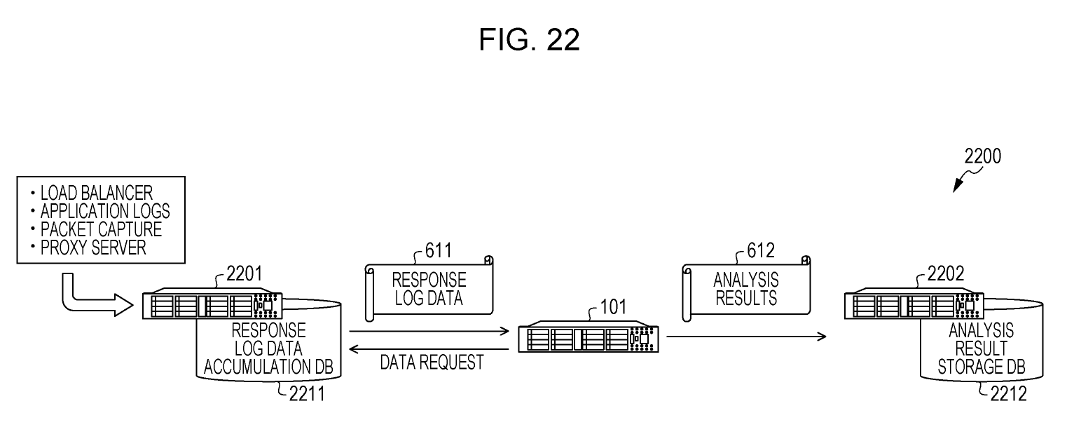

FIG. 22 is a diagram illustrating an example of the configuration of a system 2200 according to the example. The system 2200 includes a response log data accumulating server 2201, the performance degradation cause estimating device 101, and an analysis result storage server 2202.

The response log data accumulating server 2201 stores, in a response log data accumulation database (DB) 2211, data obtained from a load balancer, application logs, data obtained by packet capture, data obtained from a proxy server, and the like.

The performance degradation cause estimating device 101 requests the response log data accumulating server 2201 to provide data. The response log data accumulating server 2201 transmits the response log data 611 to the performance degradation cause estimating device 101 in accordance with the request. Then, the performance degradation cause estimating device 101 outputs the analysis results 612 to the analysis result storage server 2202. The analysis result storage server 2202 accumulates the received analysis results 612 in an analysis result storage DB 2212.

FIG. 23 is a diagram illustrating an example of the details of the stored response log data 611. The response log data 611 illustrated in FIG. 23 includes records 2301-1 to 2301-N.

The response log data 611 includes a time field, a request field, a requested URL field, an HTTP status code field, a response time field, and a body size field. In the time field, values that indicate times when requests have been received are stored. If values that indicate times when responses have been returned are stored in the time field, whether or not access is executed in the short time periods and middle time periods included in the normal time period nt and the analysis time period at may be determined based on values obtained by subtracting response times from the times when the responses have been returned. In the request field, character strings that indicate request types are stored. Specifically, in the request field, the character strings that identify methods specified in HTTP request rows are stored. The methods specified in the HTTP request rows are, GET, POST, and the like, for example.

In the requested URL field, values that indicate URLs included in the HTTP request rows are stored. In the HTTP status code field, values that indicate status codes included in HTTP response rows are stored. The status codes are 200 indicating that a request has succeeded, 404 indicating that a resource specified in a URL has not been found, and the like, for example. In the response time field, values indicating response times from times when the requests have been received to times when the responses have been returned are stored. In the body size field, values that indicate body sizes, excluding HTTP headers, of data of the responses returned for the requests are stored.

For example, the record 2301-1 indicates that a response indicating 200 is returned for access to a URL “/diagnosis?id=3” by the GET method at a time identified by 2015-12-01T17:52:35.80+0900. In addition, the record 2301-1 indicates that a response time from the time when a request has been received to the time when a response has been returned is 3.86 seconds and that a body size is 36736 bytes.

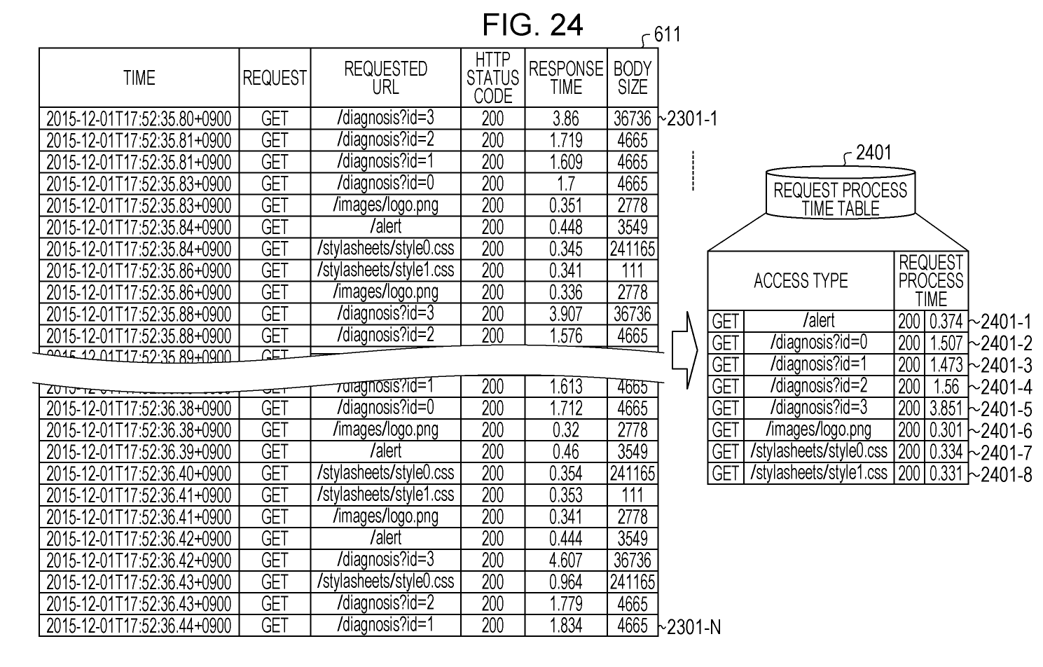

FIG. 24 is a diagram illustrating an example of the calculation of request process times. The performance degradation cause estimating device 101 stores, for each of the access types, a minimum response time or a request process time within the normal time period nt of, for example, 10 minutes from the response log data 611. FIG. 24 illustrates a request process time table 2401 storing request process times for the access types. The request process time table 2401 illustrated in FIG. 24 includes records 2401-1 to 2401-8.

The request process time table 2401 includes an access type field and a request process time field. In the access type field, information that identifies combinations of the request field, requested URL field, and HTTP status code field of the response log data 611 is stored. In the request process time field, values that indicate minimum response times for access identified by the aforementioned combinations are stored.

For example, the record 2401-1 indicates that the minimum response time among response times for access that has been executed to a URL “/alert” by the GET method and has resulted in the HTTP status code indicating 200 is 0.374 seconds.

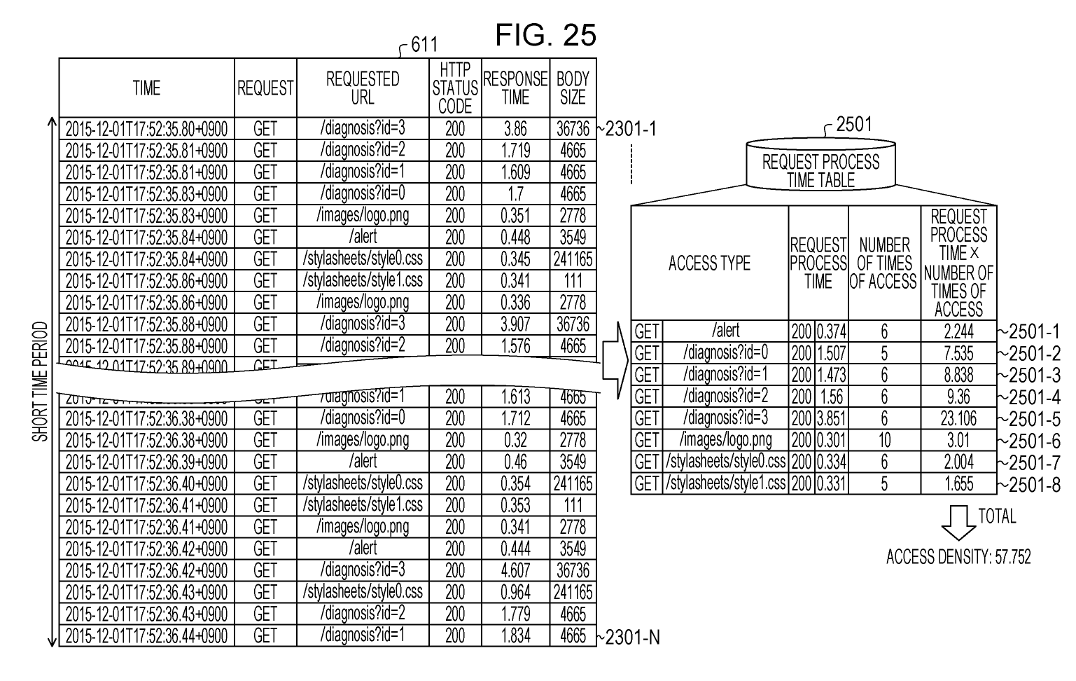

FIG. 25 is a diagram illustrating an example of the calculation of access densities. The performance degradation cause estimating device 101 calculates the total of request process times for all access or an access density for each of short time periods or, for example, every 1 second.

A request process time table 2501 illustrated in the example of FIG. 25 includes records 2501-1 to 2501-8. The records 2501-1 to 2501-8 are obtained by adding a number of times of access field and a request process time x number of times of access field to the records of the request process time table 2401. In the number of times of access field, values that indicate the numbers of times of access that are identified by the information stored in the access type field are stored. In the request process time x number of times of access field, values obtained by multiplying request process times by the numbers of the times of the access are stored. If the records 2301-1 to 2301-N indicate a single short time period, the performance degradation cause estimating device 101 calculates an access density of the short time period based on the following equation.

The access density of the short time period=0.374×6+1.507×5+ . . . +0.331×5=57.752

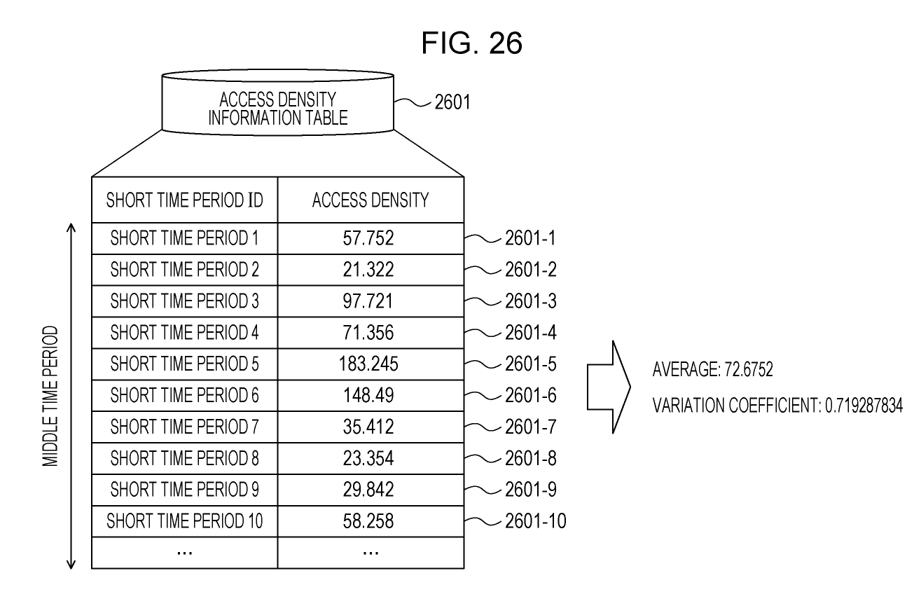

FIG. 26 is a diagram illustrating a first example of the calculation of the average of access densities and a variation coefficient of the access densities. FIG. 26 illustrates an access density information table 2601 storing access densities calculated for short time periods included in a certain middle time period among the middle time periods into which the normal time period nt is divided. Each of the middle time periods is 10 seconds, for example. The access density information table 2601 illustrated in FIG. 26 includes records 2601-1 to 2601-10.

The performance degradation cause estimating device 101 calculates an average and variation coefficient of access densities of each of the middle time periods mt. In the example illustrated in FIG. 26, the performance degradation cause estimating device 101 calculates 72.675 as the average of access densities from a group of the records included in the access density information table 2601 and calculates 0.719287834 as a variation coefficient of the access densities from the group of the records included in the access density information table 2601.

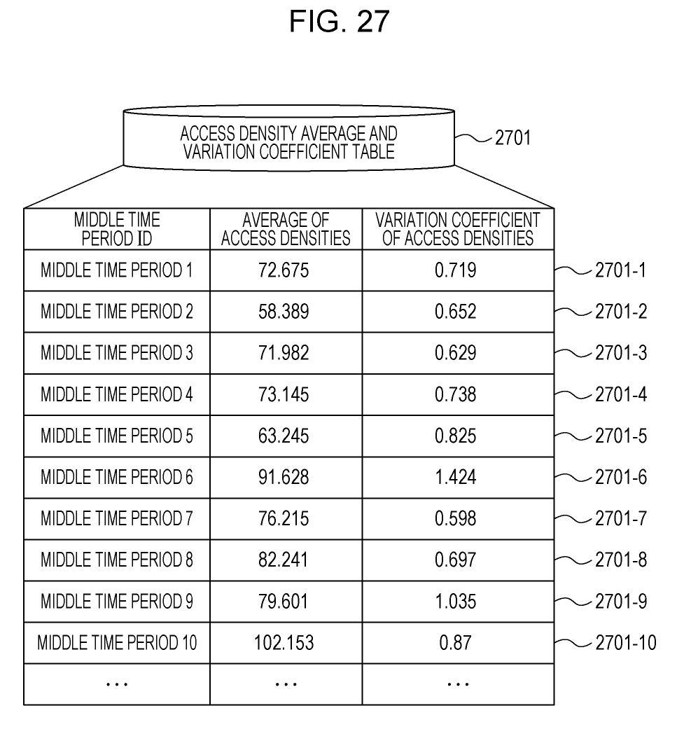

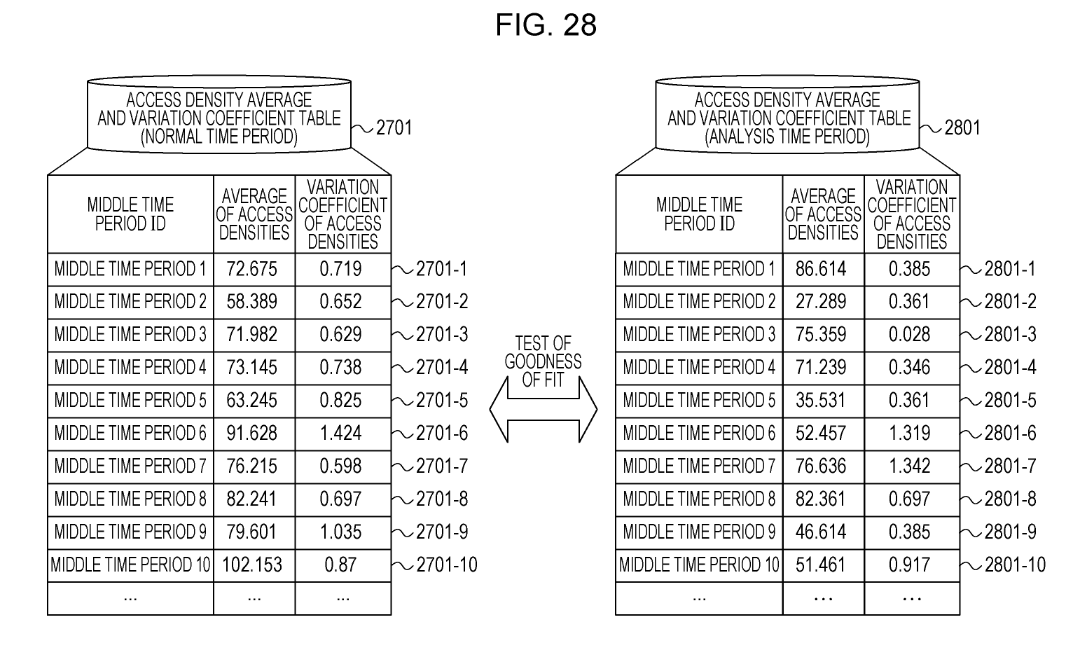

FIG. 27 is a diagram illustrating a second example of the calculation of the average of access densities and a variation coefficient of the access densities. FIG. 27 illustrates an access density average and variation coefficient table 2701 storing averages, calculated for the middle time periods, of access densities and variation coefficients, calculated for the middle time periods, of the access densities. The access density average and variation coefficient table 2701 includes records 2701-1 to 2701-10.

FIG. 28 is a diagram illustrating an example of the identification of a cause based on a test of goodness of fit. FIG. 28 illustrates the access density average and variation coefficient table 2701 indicating the normal time period nt and an access density average and variation coefficient table 2801 indicating the analysis time period at. The access density average and variation coefficient table 2801 illustrated in FIG. 28 and indicating the analysis time period at includes records 2801-1 to 2801-10. The performance degradation cause estimating device 101 references the access density average and variation coefficient tables 2701 and 2801 and conducts a test of goodness of fit of distributions of averages and variation coefficients, indicated in the access density average and variation coefficient tables 2701 and 2801, of access densities.

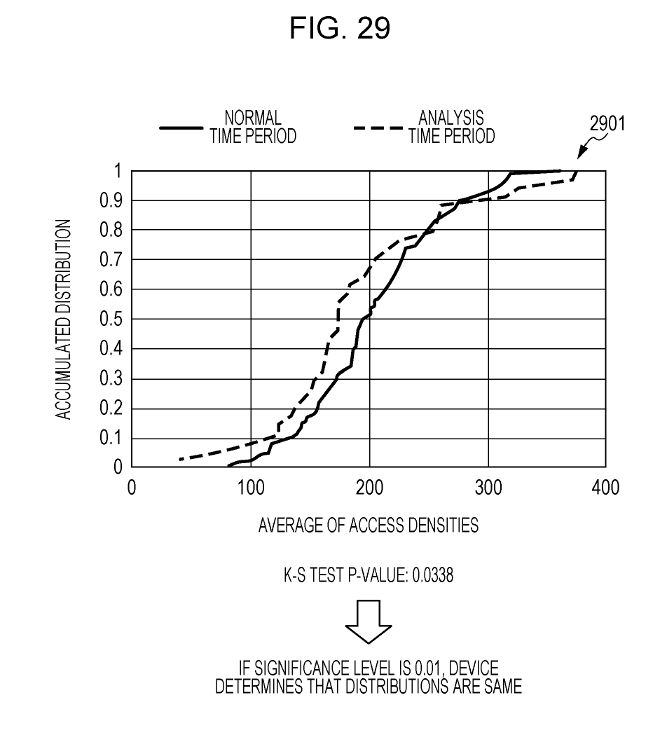

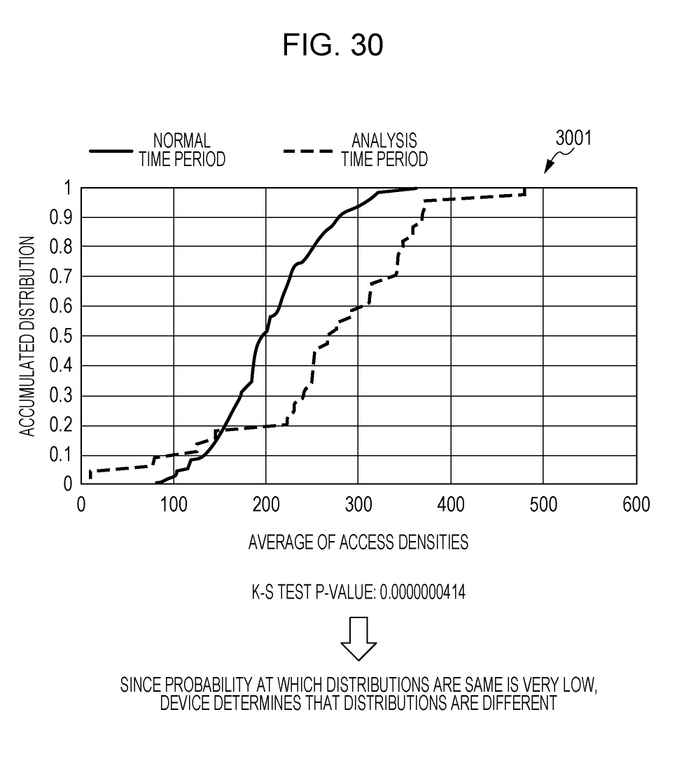

Next, two examples of the test of goodness of fit are described with reference to FIGS. 29 and 30. In FIGS. 29 and 30, data on the normal time period nt is indicated by solid lines, and data on the analysis time period at is indicated by broken lines.

FIG. 29 is a diagram illustrating an example of the test of goodness of fit. FIG. 29 illustrates a graph 2901 indicating an example of an accumulated distribution obtained in the normal time period nt and an accumulated distribution obtained in the analysis time period at. The example indicated by the graph 2901 assumes that a K-S test p-value is 0.0338. If a significance level is 0.01, the performance degradation cause estimating device 101 determines that the distributions are the same.

FIG. 30 is a diagram illustrating an example of the test of goodness of fit. FIG. 30 illustrates a graph 3001 indicating another example of the accumulated distribution obtained in the normal time period nt and the accumulated distribution obtained in the analysis time period at. The example indicated by the graph 3001 assumes that the K-S test p-value is 0.0000000414. Since a probability at which the distributions are the same is very low, the performance degradation cause estimating device 101 determines that the distributions are different from each other.

FIG. 31 is a diagram illustrating an example of output of results of estimating causes of performance degradation according to the example. In FIG. 31, specific details of the analysis result storage DB 2212 are displayed as records 3101-1 to 3101-5. FIG. 31 illustrates an example in which if the result of estimating a cause indicates that the performance degradation is caused by an increase in the access load, whether the increase is an average increase in the access load or a burst increase in the access load is displayed. For example, the record 3101-2 indicates that an event indicating that a complaint has been received has occurred at 08:15:21 on Nov. 16, 2015 and that the result of estimating the cause indicates that the performance degradation has been caused by a burst increase in the access load.

It is assumed that an administrator m illustrated in FIG. 31 is the administrator of the web application to be analyzed. In this case, the administrator m browses details of the record 3101-2 and searches, from the response log data 611, a data portion indicating a burst increase in the access load since a burst increase in an access density occurs, for example.

As described above, the performance degradation cause estimating device 101 estimates a cause of the degradation of a response time based on the determination, based on minimum response times for the access types, of whether or not a distribution of variation coefficients of access densities in the normal time period nt matches a distribution of variation coefficients of access densities in the analysis time period at. Since burst access is reflected in the variation coefficients by the estimation, and the performance degradation cause estimating device 101 may improve the accuracy of the estimation. Since the accuracy of the determination is improved, an appropriate administrator may quickly take appropriate measures.

In addition, the performance degradation cause estimating device 101 may identify the cause of the degradation of the response time based on whether or not a distribution of averages of the access densities in the normal time period nt matches a distribution of averages of the access densities in the analysis time period at. An increase in a process time due to a change in a URL is reflected in the averages of the access densities by the identification, and the performance degradation cause estimating device 101 may improve the accuracy of estimating the cause.

In addition, if the distributions of the averages in the normal and analysis time periods nt and at match each other and the distributions of the variation coefficients in the normal and analysis time periods nt and at match each other, the performance degradation cause estimating device 101 may identify that the degradation of the response time is caused by the resource competition. Thus, if the degradation of the response time is caused by the resource competition, the performance degradation cause estimating device 101 notifies the administrator of the cloud environment of the aforementioned cause, and the administrator of the cloud environment may quickly take appropriate measures such as the confirmation of the assignment of resources.

In addition, if the distributions of the averages in the normal and analysis time periods nt and at do not match each other or if the distributions of the variation coefficients in the normal and analysis time periods nt and at do not match each other, the performance degradation cause estimating device 101 may identify that the degradation of the response time is caused by an increase in the access load. Thus, if the degradation is caused by the increase in the access load, the performance degradation cause estimating device 101 notifies the administrator of the web application of the aforementioned cause, and the administrator who received the notification may quickly take appropriate measures such as the confirmation of the response log data 611 and the confirmation of details of a process of the web application.

If the distributions of the variation coefficients in the normal and analysis time periods nt and at are different from each other, the performance degradation cause estimating device 101 may identify that the degradation of the response time is caused by a burst increase in the access load. Thus, if the degradation of the response time is caused by the burst increase in the access load, the performance degradation cause estimating device 101 may notify the administrator of the web application of the aforementioned cause. Then, the administrator who received the notification may quickly take appropriate measures such as the confirmation of a data portion indicating the burst increase from the response log data 611.

If the distributions of the averages in the normal and analysis time periods nt and at are different from each other, the performance degradation cause estimating device 101 may identify that the degradation of the response time is caused by an average increase in the access load. If the degradation of the response time is caused by the average increase in the access load, the performance degradation cause estimating device 101 may notify the administrator of the web application of the aforementioned cause. The administrator who received the notification may quickly take appropriate measures such as the confirmation of details of a process of the web application from the response log data 611.

In addition, the performance degradation cause estimating device 101 ma identify the analysis time period at based on the time when a response time for access has exceeded the predetermined threshold. Thus, the performance degradation cause estimating device 101 may identify, as the analysis time period at, a time period in which the response time for the access increases, and the performance degradation cause estimating device 101 may estimate a cause of the degradation of the response time.

In addition, the performance degradation cause estimating device 101 may identify the analysis time period at based on the time when a complaint has arisen from the user of the web application that is a destination of access. Thus, the performance degradation cause estimating device 101 may identify, as the analysis time period at, a time period recognized by the user as a time period in which the response time for the access increases, and the performance degradation cause estimating device 101 may estimate a cause of the degradation of the response time.

The method, described in the embodiment, of estimating a cause of performance degradation may be achieved by causing a computer such as a personal computer or a workstation to execute the program prepared in advance. This performance degradation cause estimation program is stored in a computer-readable storage medium such as a hard disk, a flexible disk, a compact disc-read only memory (CD-ROM), or a digital versatile disc (DVD) and read by the computer from the storage medium and executed by the computer. The performance degradation cause estimation program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable and non-transitory storage medium having stored a performance degradation cause estimation program that causes a computer to execute a process, the process comprising:
calculating, by referencing a memory storing response times for accesses of multiple access types and for each of the access types, first access densities in respective time periods obtained by dividing a first time period by a first time length, wherein the first access densities are obtained by multiplying the numbers of appearances of the access type in the respective time periods by a first minimum response time for the access type;
calculating, based on the calculated first access densities, first variation coefficients of the first access densities in respective time periods obtained by dividing the first time period by a second time length that is longer than the first time length, for each of the access types;
calculating, by referencing the memory and for each of the access types, second access densities in respective time periods obtained by dividing a second time period, different from the first time period and identified as a time period in which a response time for the access increases, by a third time length, wherein the second access densities are obtained by multiplying the numbers of appearances of the access type in the respective time periods obtained by dividing the second time period by the third time length by a second minimum response time for the access type in the second time period;
calculating, based on the calculated second access densities , second variation coefficients of the second access densities in respective time periods obtained by dividing the second time period by a fourth time length that is longer than the third time length; and
identifying a cause of the increase in the response time within the second time period based on the result of a test of goodness of fit of a distribution of the first variation coefficients and a distribution of the second variation coefficients.

2. The storage medium according to claim 1,
wherein the first minimum response time for the access type is the minimum value among response times for the access type in each of first time periods and is determined for each of the first time periods.

3. The storage medium according to claim 1, the process further comprising:
calculating, based on the calculated first access densities in the respective time periods obtained by dividing the first time period by the first time length, first averages of the first access densities in the respective time periods obtained by dividing the first time period by the second time length;
calculating, based on the calculated second access densities in the respective time periods obtained by dividing the second time period by the third time length, second averages of the second access densities in the respective time periods obtained by dividing the second time period by the fourth time length; and
identifying the cause of the increase in the response time in the second time period based on the result of a test of goodness of fit of a distribution of the first averages and a distribution of the second averages.

4. The storage medium according to claim 3,
wherein the identifying is to identify that the increase in the response time is caused by a resource competition if the result of the test of goodness of fit of the distributions of the first and the second variation coefficients indicates that the distributions are the same and the result of the test of goodness of fit of the distributions of the first and the second averages indicates that the distributions are the same.

5. The storage medium according to claim 3,
wherein the identifying is to identify that the increase in the response time is caused by an increase in an access load if the result of the test of goodness of fit of the distributions of the first and the second variation coefficients indicates that the distributions are different from each other or if the result of the test of goodness of fit of the distributions of the first and the second averages indicates that the distributions are different from each other.

6. The storage medium according to claim 5,
wherein the identifying is to identify that the increase in the response time is caused by a burst increase in an access load if the result of the test of goodness of fit of the distributions of the first and the second variation coefficients indicates that the distributions are different from each other.

7. The storage medium according to claim 5,
wherein the identifying is to identify that the increase in the response time is caused by an average increase in an access load if the result of the test of goodness of fit of the distributions of the first and the second averages indicates that the distributions are different from each other.

8. The storage medium according to claim 1, the process further comprising
identifying the second time period based on the time when the response time for the access has exceeded a predetermined threshold.

9. The storage medium according to claim 1, the process further comprising
identifying the second time period based on the time when a complaint has arisen from a user of software that is a destination of the access.

10. A performance degradation cause estimating device comprising:
a memory; and
a processor coupled to the memory and configured to execute a process including
calculating, by referencing the memory storing response times for accesses of multiple access types and for each of the access types, first access densities in respective time periods obtained by dividing a first time period by a first time length, wherein the first access densities are obtained by multiplying the numbers of appearances of the access type in the time periods by a minimum response time for the access type;
calculating, based on the calculated first access densities, first variation coefficients of the first access densities in respective time periods obtained by dividing the first time period by a second time length that is longer than the first time length, for each of the access types;
calculating, by referencing the memory and for each of the access types, second access densities in respective time periods obtained by dividing a second time period, different from the first time period and identified as a time period in which a response time for the access increases, by a third time length, wherein the second access densities are obtained by multiplying the numbers of appearances of the access type in the respective time periods obtained by dividing the second time period by the third time length by a minimum response time for the access type in the second time period;
calculating, based on the calculated second access densities, second variation coefficients of access densities in respective time periods obtained by dividing the second time period by a fourth time length that is longer than the third time length; and
identifying a cause of the increase in the response time within the second time period based on the result of a test of goodness of fit of a distribution of the first variation coefficients and a distribution of the second variation coefficients.

11. A performance degradation cause estimation method that causes a computer to execute a process, the process comprising:
Calculating, by referencing a memory storing response times for accesses of multiple access types and for each of the access types, first access densities in respective time periods obtained by dividing a first time period by a first time length, wherein the first access densities are obtained by multiplying the numbers of appearances of the access type in the respective time periods by a minimum response time for the access type;
calculating, based on the calculated first access densities, first variation coefficients of the first access densities in respective time periods obtained by dividing the first time period by a second time length that is longer than the first time length, for each of the access types;
calculating, by referencing the memory and for each of the access types, second access densities in respective time periods obtained by dividing a second time period, different from the first time period and identified as a time period in which a response time for the access increases, by a third time length, wherein the second access densities are obtained by multiplying the numbers of appearances of the access type in the respective time periods obtained by dividing the second time period by the third time length by a minimum response time for the access type in the second time period;
calculating, based on the calculated second access densities, second variation coefficients of the second access densities in respective time periods obtained by dividing the second time period by a fourth time length that is longer than the third time length; and
identifying a cause of the increase in the response time within the second time period based on the result of a test of goodness of fit of a distributions of the first and the second variation coefficients.
